(19) United States
(12) Patent Application Publication
(10) Pub. No.: US 2023/0186047 A1
(43) Pub. Date: Jun. 15, 2023

(54) EVALUATION METHOD, EVALUATION DEVICE, AND COMPUTER PROGRAM

(71) Applicant: SEIKO EPSON CORPORATION, TOKYO (JP)

(72) Inventors: Hikaru KURASAWA, Matsumoto-shi (JP); Yuki URUSHIBATA, Shiojiri-Shi (JP); Ryoki WATANABE, Matsumoto-shi (JP); Shin NISHIMURA, Shiojiri-Shi (JP); Eiichiro YAMAGUCHI, Matsumoto-shi (JP)

(21) Appl. No.: 18/063,897

(22) Filed: Dec. 9, 2022

(30) Foreign Application Priority Data
Dec. 10, 2021 (JP) 2021-200534

(51) Int. Cl. G06N 3/04; G06N 3/08

(52) U.S. Cl. CPC G06N 3/04; G06N 3/08

(57) ABSTRACT

An evaluation method for a trained machine learning model includes the steps of (a) inputting evaluation data to the trained machine learning model to generate first explanatory information used for an evaluation of the machine learning model, (b) using a value indicated by each piece of information included in the first explanatory information to generate second explanatory information indicating an evaluation of the trained machine learning model, and (c) outputting the generated second explanatory information.

The present application is based on, and claims priority from JP Application Serial Number 2021-200534, filed Dec. 10, 2021, the disclosure of which is hereby incorporated by reference herein in its entirety.

### BACKGROUND

### 1. Technical Field

The present disclosure relates to a technique for evaluating a trained machine learning model.

### 2. Related Art

U.S. Pat. No. 5,210,798 and WO 2019/083553 disclose a so-called capsule network as a vector neural network type machine learning model using a vector neuron. The vector neuron means a neuron whose input and output are vectors. The capsule network is a machine learning model in which a vector neuron called a capsule is a node of the network. The vector neural network type machine learning model such as the capsule network can be used for class discrimination of input data.

In the related art, there may occur an event in which a trained machine learning model does not match an initial target, such as not reaching a desired discrimination accuracy. Evaluation of the trained machine learning model, such as identification of the cause of this event, is likely to differ between users depending on user experience, etc. Therefore, there has been a demand for a technique capable of evaluating the trained machine learning model without causing a difference between users. The evaluation of the trained machine learning model includes an evaluation of evaluation data used for an evaluation of the trained machine learning model in addition to the evaluation of the trained machine learning model itself.

### SUMMARY

According to a first aspect of the present disclosure, there is provided an evaluation method for a trained machine learning model. The machine learning model is a vector neural network model including a plurality of vector neuron layers, and is trained by using a plurality of pieces of training data including input data and a prior label associated with the input data. The evaluation method includes the steps of (a) inputting evaluation data to the trained machine learning model to generate first explanatory information used for an evaluation of the machine learning model, (b) using a value indicated by each piece of information included in the first explanatory information to generate second explanatory information indicating an evaluation of the trained machine learning model, and (c) outputting the generated second explanatory information, wherein the step (a) includes the steps of (a1) inputting the evaluation data to the trained machine learning model to obtain a feature spectrum from an output of a specific layer of the trained machine learning model, (a2) obtaining a spectral similarity that is a similarity between the feature spectrum and a known feature spectrum included in a known feature spectrum group obtained from an output of the specific layer by inputting the plurality of pieces of training data to the trained machine learning model again, for each of a plurality of the known feature spectra included in the known feature spectrum group, (a3) obtaining a data similarity that is a similarity between the input data and the evaluation data, and (a4) generating the first explanatory information including spectral similarity information related to the spectral similarity and data similarity information related to the data similarity.

According to a second aspect of the present disclosure, there is provided an evaluation device for a trained machine learning model. The evaluation device includes a memory configured to store the machine learning model, the machine learning model being a vector neural network model including a plurality of vector neuron layers, the machine learning model being trained by using a plurality of pieces of training data including input data and a prior label associated with the input data, and a processor, wherein the processor is configured to execute processing of (a) inputting evaluation data to the trained machine learning model to generate first explanatory information used for an evaluation of the machine learning model, (b) using a value indicated by each piece of information included in the first explanatory information to generate second explanatory information indicating an evaluation of the trained machine learning model, and (c) outputting the generated second explanatory information, wherein the processing (a) includes processing of (a1) inputting the evaluation data to the trained machine learning model to obtain a feature spectrum from an output of a specific layer of the trained machine learning model, (a2) obtaining a spectral similarity that is a similarity between the feature spectrum and a known feature spectrum included in a known feature spectrum group obtained from an output of the specific layer by inputting the plurality of pieces of training data to the trained machine learning model again, for each of a plurality of the known feature spectra included in the known feature spectrum group, (a3) obtaining a data similarity that is a similarity between the input data and the evaluation data, and (a4) generating the first explanatory information including spectral similarity information related to the spectral similarity and data similarity information related to the data similarity.

According to a third aspect of the present disclosure, there is provided a non-transitory computer-readable storage medium storing a program for causing a computer to execute evaluation of a trained machine learning model. The machine learning model is a vector neural network model including a plurality of vector neuron layers, and is trained by using a plurality of pieces of training data including input data and a prior label associated with the input data. The computer program causes the computer to execute the following functions (a) inputting evaluation data to the trained machine learning model to generate first explanatory information used for an evaluation of the machine learning model, (b) using a value indicated by each piece of information included in the first explanatory information to generate second explanatory information indicating an evaluation of the trained machine learning model, and (c) outputting the generated second explanatory information, wherein the function (a) includes the following functions (a1) inputting the evaluation data to the trained machine learning model to obtain a feature spectrum from an output of a specific layer of the trained machine learning model, (a2) obtaining a spectral similarity that is a similarity between the feature spectrum and a known feature spectrum included in a known feature spectrum group obtained from an output of the specific layer by inputting the plurality of pieces of training data to the trained machine learning model again, for each of a plurality of the known feature spectra included in the known feature spectrum group, (a3) obtaining a data similarity that is a similarity between the input data and the evaluation data, and (a4) generating the first explanatory information including spectral similarity information related to the spectral similarity and data similarity information related to the data similarity.

### BRIEF DESCRIPTION OF THE DRAWINGS

FIG. 1 is a block diagram illustrating an evaluation system according to a first exemplary embodiment.

FIG. 2 is an explanatory diagram illustrating a configuration of a machine learning model.

FIG. 3 is a flowchart illustrating a training process of the machine learning model.

FIG. 4 is a diagram for explaining training data.

FIG. 5 is an explanatory diagram illustrating a feature spectrum.

FIG. 6 is an explanatory diagram illustrating a configuration of a known feature spectrum group.

FIG. 7 is a flowchart of an evaluation process executed by an evaluation processing unit.

FIG. 8 is a first diagram for explaining first explanatory information.

FIG. 9 is a second diagram for explaining the first explanatory information.

FIG. 10 is an explanatory diagram illustrating a first calculation method of a maximum spectral similarity.

FIG. 11 is a diagram illustrating a second calculation method of the maximum spectral similarity.

FIG. 12 is an explanatory diagram illustrating a third calculation method of the maximum spectral similarity.

FIG. 13 is a diagram illustrating a histogram of an individual local spectral similarity.

FIG. 14 is a diagram illustrating a histogram of an individual spectral similarity.

FIG. 15 is a diagram for explaining a data similarity.

FIG. 16 is a first flowchart illustrating the details of step S30.

FIG. 17 is a second flowchart illustrating the details of step S30.

FIG. 18 is a third flowchart illustrating the details of step S30.

FIG. 19 is a fourth flowchart illustrating the details of step S30.

### DESCRIPTION OF EXEMPLARY EMBODIMENTS

A. Exemplary Embodiment:

### A-1. Overview of an Evaluation System:

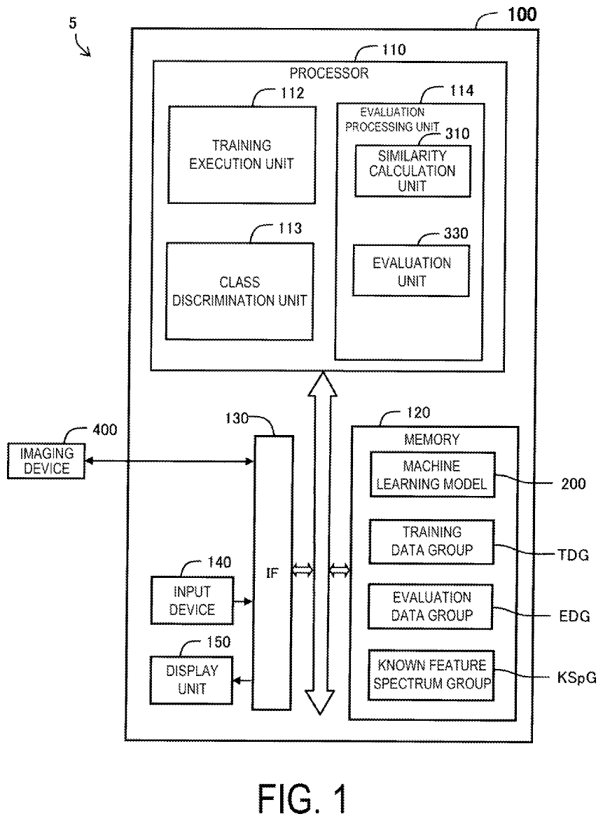

FIG. 1 is a block diagram illustrating an evaluation system 5 according to a first exemplary embodiment. The evaluation system 5 includes an evaluation device 100 and an imaging device 400 as a sensor. The imaging device 400 captures an image of a target object to acquire a captured image. The captured image obtained by the imaging device 400 is used as data used for training, evaluation, and class discrimination of a machine learning model 200. The evaluation device 100 executes a training process of the machine learning model 200, an evaluation process of the trained machine learning model 200, and a class discrimination process of data using the trained machine learning model 200. The evaluation device 100 only needs to be able to execute at least the evaluation process, and a device different from the evaluation device 100 may execute the training process or the discrimination process. The “class of data” means a type of data. The evaluation device 100 may output the discriminated type of data to a display unit that is an output unit. In this manner, a user can easily grasp the type of data. Note that the evaluation system according to the present disclosure can be realized as a system other than the above, and for example, the evaluation process may be executed using data such as one dimensional data or time-series data.

The evaluation device 100 includes a processor 110, a memory 120, an interface circuit 130, and an input device 140 and a display unit 150 coupled to the interface circuit 130. The evaluation device 100 is, for example, a personal computer. The imaging device 400 is also coupled to the interface circuit 130. Although not limited thereto, for example, the processor 110 not only has a function of executing processes described in detail below but also has a function of displaying data obtained by the process and data generated in the course of the process on the display unit 150.

The processor 110 includes a training execution unit 112, a class discrimination unit 113, and an evaluation processing unit 114 by executing various programs stored in the memory 120. The training execution unit 112 executes the training process of the machine learning model 200 using a training data group TDG. The class discrimination unit 113 inputs data IM to the trained machine learning model 200 to execute class discrimination of the input data IM. The evaluation processing unit 114 inputs evaluation data ED to the trained machine learning model 200 to generate first explanatory information FEI, and generates second explanatory information SEI indicating an evaluation of the machine learning model 200 from the first explanatory information FEI. The generated secondary explanatory information SEI is output to the display unit 150.

The evaluation processing unit 114 includes a similarity calculation unit 310 and an evaluation unit 330. The similarity calculation unit 310 inputs the evaluation data ED to the trained machine learning model 200 to generate the first explanatory information FEI including spectral similarity information IRSp and data similarity information IDa. The spectral similarity information IRSp is information indicating a degree of similarity between a known feature spectrum KSp obtained by inputting the training data TD to the trained machine learning model 200 and a feature spectrum Sp obtained by inputting the evaluation data ED to the trained machine learning model 200. The data similarity information IDa is information indicating a data similarity Da between the training data TD of a generation source of a specific known feature spectrum KSp specified based on a spectral similarity RSp between the known feature spectrum KSp and the feature spectrum Sp, and the evaluation data ED. The first explanatory information FEI is used to evaluate the trained machine learning model 200. The evaluation unit 330 generates the second explanatory information SEI indicating an evaluation of the trained machine learning model 200 by using values indicated by various kinds of information included in the first explanatory information FEI.

In the above description, at least a part of the functions of the training execution unit 112, the class discrimination unit 113, and the evaluation processing unit 114 may be realized by a hardware circuit. The processor in this specification is a term including such a hardware circuit. The processor that executes the class discrimination process may be one or more processors included in one or more remote computers coupled to the evaluation device 100 via a network.

The memory 120 stores the machine learning model 200, the training data group TDG, an evaluation data group EDG, and a known feature spectrum group KSpG. The machine learning model 200 is used for class discrimination of the input data IM. Each machine learning model 200 is a vector neural network type machine learning model having a plurality of vector neuron layers. The machine learning model 200 is trained using a plurality of pieces of the training data TD. A configuration example and an operation of the machine learning model 200 will be described later.

The training data group TDG is a set of the training data TD that is supervised data. In the present exemplary embodiment, each training data TD of the training data group TDG includes input data IM and a prior label LB associated with the input data IM. In the present exemplary embodiment, the input data IM is a captured image of a target object captured by the imaging device 400. In the present exemplary embodiment, the prior label LB is a label indicating a type of the target object. In the present exemplary embodiment, the “label” and “class” have the same meaning.

The evaluation data group EDG is a set of the evaluation data ED used for evaluating the trained machine learning model 200. The evaluation data ED is at least one type of data of: the training data TD; verification data VD; and abnormality data AD. The training data TD is data of the training data group TDG used for training of the machine learning model 200. The verification data VD is data that is not used for training the machine learning model 200 and includes the input data IM and the prior label LB associated with the input data IM. In the present exemplary embodiment, the verification data VD is data generated by cross-validation on the training data group TDG. That is, a part of the plurality of piece of training data TD prepared for training is used as the verification data VD. The abnormal data AD is the input data IM with which the prior label LB is not associated. The abnormal data AD is the input data IM assumed to be classified as an unknown-class different from the class corresponding to the prior label LB by the machine learning model 200.

The known feature spectrum group KSpG is a set of the feature spectra Sp obtained when the training data group TDG is input to the trained machine learning model 200. The feature spectrum Sp will be described later. Note that feature spectrum Sp of the known feature spectrum group KSpG is also referred to as the known feature spectrum KSp.

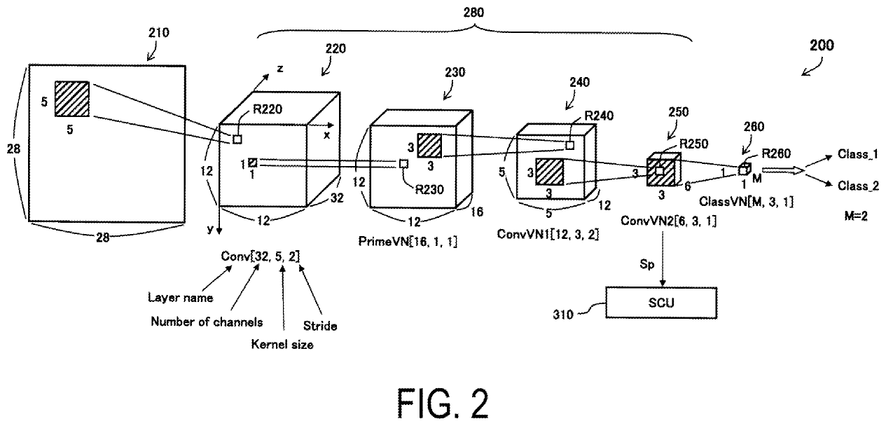

FIG. 2 is an explanatory diagram illustrating a configuration of the machine learning model 200. The machine learning model 200 includes an input layer 210, an intermediate layer 280, and an output layer 260. The intermediate layer 280 includes a convolution layer 220, a primary vector neuron layer 230, a first convolution vector neuron layer 240, and a second convolution vector neuron layer 250. Among these layers, the input layer 210 is the lowest layer and the output layer 260 is the highest layer. In the following description, the layers of the intermediate layer 280 will be referred to as “Cony layer 220”, “PrimeVN layer 230”, “ConvVN1 layer 240”, and “ConvVN2 layer 250”, respectively, and the output layer 260 will be referred to as “ClassVN layer 260”.

Although two convolution vector neuron layers 240, 250 are used in the example of FIG. 2, the number of convolution vector neuron layers is arbitrary, and the convolution vector neuron layer may be omitted. However, it is preferable to use one or more convolution vector neuron layers.

A captured image having a size of 28 x 28 pixels is input to the input layer 210. The configuration of each layer other than the input layer 210 can be described as follows.

Conv layer 220: Conv [32, 5, 2]

PrimeVN layer 230: PrimeVN [16, 1, 1]

ConvVN1 layer 240: ConvVN1 [12, 3, 2]

ConvVN2 layer 250: ConvVN2 [6, 3, 1]

ClassVN layer 260: ClassVN [M, 3, 1]

Vector dimension VD: VD=16

In the description of each layer, a character string before parentheses is a layer name, and numbers in the parentheses are the number of channels, the surface size of the kernel, and the stride in this order. For example, the layer name of the Conv layer 220 is “Conv”, the number of channels is 32, the surface size of the kernel is 5×5, and the stride is 2. In FIG. 2, these descriptions are illustrated below each layer. A hatched rectangle drawn in each layer represents a surface size of a kernel used when calculating an output vector of an adjacent upper layer. In the present exemplary embodiment, since the input data is image data, the surface size of the kernel is also two dimensional. Note that the values of the parameters used in the description of each layer are examples, and can be arbitrarily changed.

The input layer 210 and the Conv layer 220 are layers composed of scalar neurons. The other layers 230 to 260 are layers composed of vector neurons. The vector neuron is a neuron whose input and output are vectors. In the above description, the dimension of the output vector of the individual vector neuron is constant at 16. Hereinafter, the term “node” is used as a superordinate concept of the scalar neuron and the vector neuron.

In FIG. 2, for the Conv layer 220, a first axis x and a second axis y that define the plane coordinates of the node array and a third axis z that represents the depth are illustrated. It is also illustrated that the size of the Conv layer 220 in the x, y, and z directions is 12, 12, 32. The size in the x direction and the size in the y direction are referred to as “resolution”. The size in the z direction is the number of channels. These three axes x, y, and z are also used as coordinate axes indicating the position of each node in other layers. However, in FIG. 2, the axes x, y, and z are not illustrated in the layers other than the Conv layer 220.

As is well known, a post-convolution resolution W1 is given by:

W1=Ceil{(W0−Wk+1)/S} (A1)

Where, W0 is a pre-convolution resolution, Wk is a surface size of the kernel, S is a stride, and Ceil {X} is a function for rounding up the fractional part of X.

The resolution of each layer illustrated in FIG. 2 is an example in the case where the resolution of the input data is 28, and the actual resolution of each layer is appropriately changed according to the size of the input data IM.

The ClassVN layer 260 has M channels. M is the number of classes discriminated by the machine learning model 200. In the present exemplary embodiment, M is 2, and two class determination values Class_1 and Class_2 are output. The number of channels M of the ClassVN layer 260 can be set to an arbitrary integer of 2 or more. When both of the two class determination values Class_1 and Class_2 are less than a threshold, an unknown-class indicating that the data belongs to a class different from that of the training data TD used for training is output as the class discrimination result.

In FIG. 2, a partial region Rn of each layer 220, 230, 240, 250, 260 is further illustrated. The suffix “n” of the partial region Rn is a symbol of each layer. For example, the partial region R220 indicates a partial region in the Conv layer 220. The “partial region Rn” is a region that is specified by a planar position (x, y) defined by the position of the first axis x and the position of the second axis y in each layer and includes a plurality of channels along the third axis z. The partial region Rn has dimensions of “Width”×“Height”×“Depth” corresponding to the first axis x, the second axis y, and the third axis z. In the present exemplary embodiment, the number of nodes included in one “partial region Rn” is “1×1 x depth number”, that is, “1×1×channel number”.

As illustrated in FIG. 2, the feature spectrum Sp described later is calculated from the output of the ConvVN2 layer 250. The similarity calculation unit 310 calculates the spectral similarity RSp between each of the training data TD and the evaluation data ED using the feature spectrum Sp. The spectral similarity RSp is used to generate the spectral similarity information IRSp. In addition, the similarity calculation unit 310 uses the spectral similarity RSp to generate the data similarity Da from which the data similarity information IDa is derived.

In the present disclosure, the vector neuron layer used for calculating the spectral similarity RSp is also referred to as a “specific layer”. As the specific layer, a vector neuron layer other than the ConvVN2 layer 250 may be used, and an arbitrary number of one or more vector neuron layers can be used. Further, a configuration of the feature spectrum Sp, a generation method of the spectral similarity information IRSp, and a generation method of the data similarity information IDa will be described later.

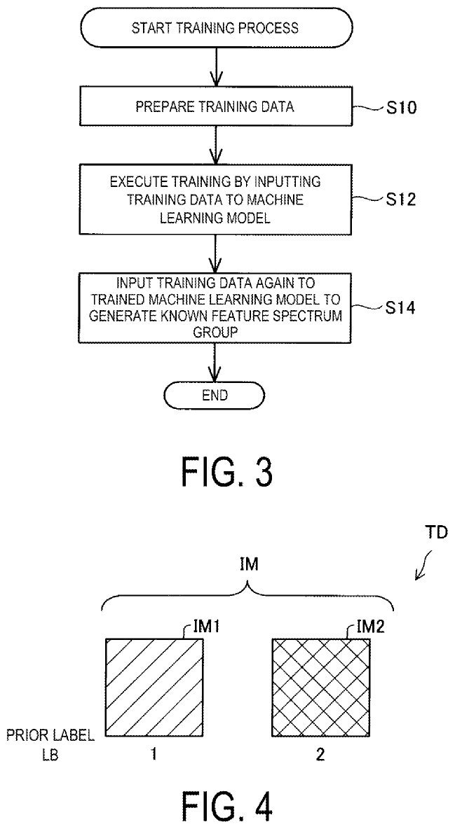

FIG. 3 is a flowchart illustrating a training process of the machine learning model 200. FIG. 4 is a diagram for explaining the training data TD. As illustrated in FIG. 3, in step S10, the plurality of piece of training data TD including the input data IM that is a captured image of a target object and the prior label LB associated with the input data IM are prepared. As illustrated in FIG. 4, the input data IM is acquired by capturing an image of the target object whose class classified by type is known in advance by the imaging device 400. In addition, the training data TD is generated by associating the prior label LB corresponding to the type known in advance with the input data IM. In the present exemplary embodiment, the prior labels LB are two labels “1” and “2”. The labels 1 and 2, which are the corresponding prior labels LB, are associated with the input data IM1 and IM2. The plurality of pieces of training data TD are stored in the memory 120 as the training data group TDG.

As illustrated in FIG. 3, in step S12, the training execution unit 112 executes training by inputting the training data group TDG to the machine learning model 200. Specifically, the training execution unit 112 executes the training of the machine learning model 200 so as to reproduce a correspondence between the input data IM and the prior label LB associated with the input data IM. When the training of the machine learning model 200 is completed, the trained machine learning model 200 is stored in the memory 120.

In step S14, the training execution unit 112 generates the known feature spectrum group KSpG by inputting the training data group TDG used for training again to the trained machine learning model 200. The generated known feature spectrum group KSpG is stored in the memory 120. The known feature spectrum group KSpG is a set of the known feature spectra KSp to be described below.

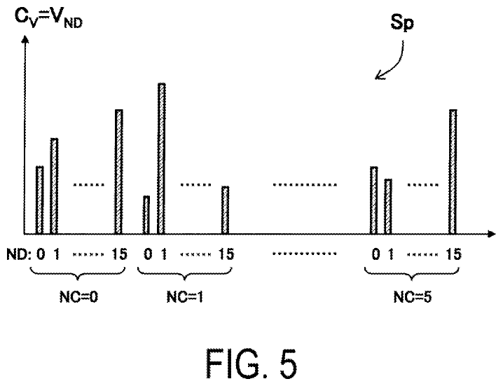

FIG. 5 is an explanatory diagram illustrating the feature spectrum Sp obtained by inputting arbitrary input data to the trained machine learning model 200. As illustrated in FIG. 2, in the present exemplary embodiment, the feature spectrum Sp is created from the output of the ConvVN2 layer 250. The horizontal axis of FIG. 5 represents the positions of vector elements related to vectors outputted from a plurality of nodes included in one partial region R250 of the ConvVN2 layer 250. The position of the vector element is represented by a combination of an element number ND of the output vector at each node and a channel number NC. In the present exemplary embodiment, since the vector dimension is 16 (the number of elements of the output vector output by each node), the element number ND of the output vector is 16 (from 0 to 15). Since the number of channels in the ConvVN2 layer 250 is 6, the channel number NC is 6 (from 0 to 5). In other words, the feature spectrum Sp is obtained by arranging a plurality of element values of vectors outputted from the vector neurons included in one partial region R250 over a plurality of channels along the third Z-axis.

The vertical axis of FIG. 5 represents a feature value CV at each spectral position. In this example, the feature value CV is a value VND of each element of the output vector. The feature value CV may be subjected to a statistical process such as centering on an average value 0. As the feature value CV, a value obtained by multiplying the value VND of each element of the output vector by a normalization coefficient to be described later may be used, or the normalization coefficient may be used as it is. In the latter case, the number of feature values CV included in the feature spectrum Sp is equal to the number of channels, that is, 6. The normalization coefficient is a value corresponding to the vector length of the output vector of the node.

The number of feature spectra Sp obtained from the output of the ConvVN2 layer 250 for one piece of the input data IM is equal to the number of planar positions (x, y) of the ConvVN2 layer 250, i.e., the number of partial regions R250, and is therefore 9.

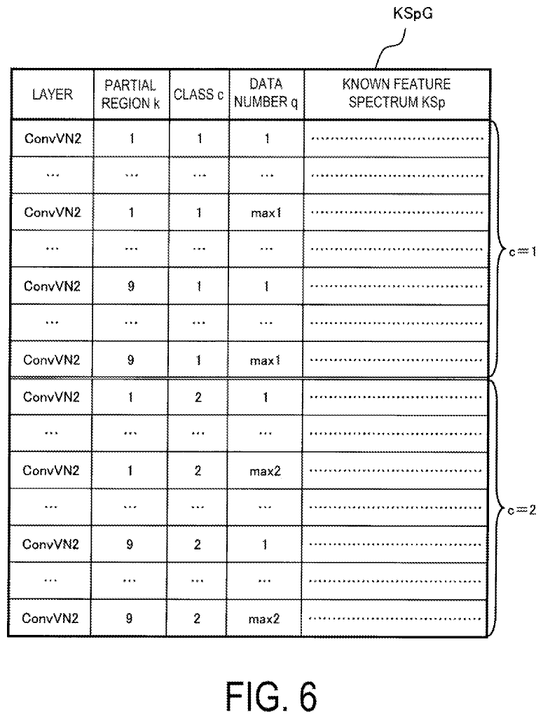

FIG. 6 is an explanatory diagram illustrating a configuration of the known feature spectrum group KSpG. In this example, the known feature spectrum group KSpG obtained from the output of the ConvVN2 layer 250 is illustrated. As the known feature spectrum group KSpG, a group obtained from an output of at least one vector neuron layer may be registered, and a known feature spectrum group obtained from an output of the ConvVN1 layer 240 or the ClassVN layer 260 may be registered.

Each record of the known feature spectrum group KSpG includes a parameter k indicating an order of the partial region Rn in the layer, a parameter c indicating the class, a parameter q indicating the data number, and the known feature spectrum KSp. The known feature spectrum KSp is the same as the feature spectrum Sp in FIG. 5.

The parameter k of the partial region Rn takes a value indicating one of the plurality of partial regions Rn included in the specific layer, that is, one of the planar positions (x, y). In the ConvVN2 layer 250, the number of the partial regions R250 is 9, therefore k=1 to 9. The parameter c representing the class takes a value indicating one of the M classes that can be discriminated by the machine learning model 200. In the present exemplary embodiment, M=2, therefore c=1 to 2. The parameter q of the data number indicates the serial number of the training data belonging to each class, takes a value from 1 to max1 for c=1, and takes a value from 1 to max2 for c=2. As described above, the feature spectrum Sp is associated with the class c and the data number q of the training data. The feature spectra Sp are classified into classes.

A-2. Summary description of an evaluation process:

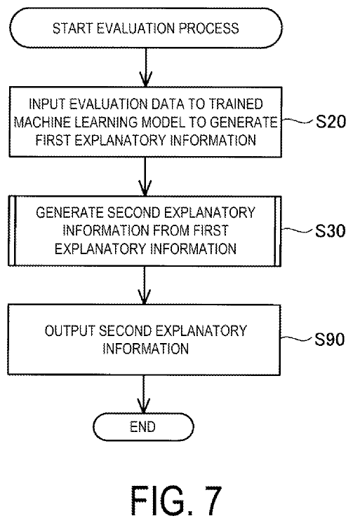

FIG. 7 is a flowchart of an evaluation process executed by the evaluation processing unit 114. The evaluation process can be executed after completion of the training process illustrated in FIG. 3. In step S20, the similarity calculation unit 310 inputs the evaluation data ED to the trained machine learning model 200 to generate the first explanatory information FEI. Next, in step S30, the evaluation unit 330 generates the second explanatory information SEI from the first explanatory information FEI. Next, in step S90, the evaluation unit 330 outputs the second explanatory information SEI to the display unit 150.

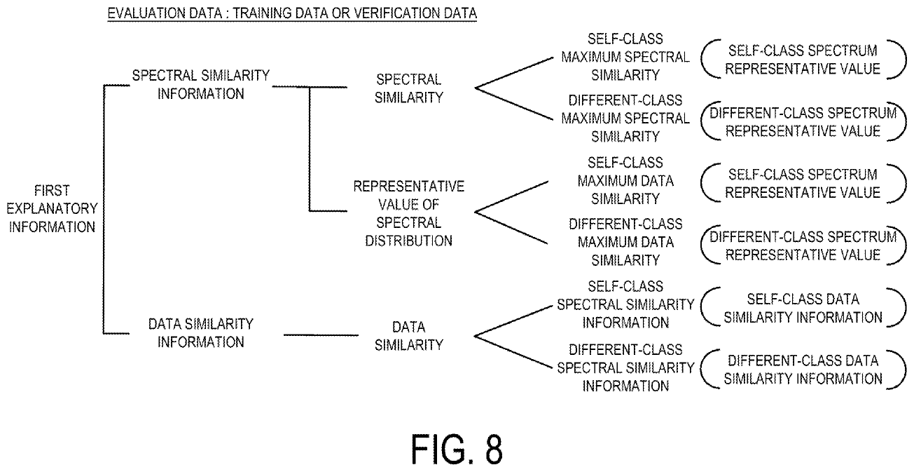

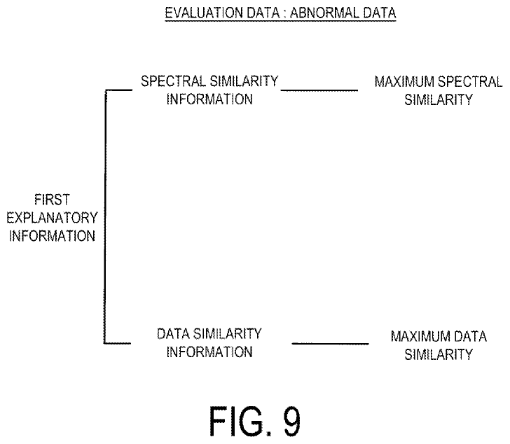

FIG. 8 is a first diagram illustrating the first explanatory information FEI. FIG. 9 is a second diagram illustrating the first explanatory information FEI. FIG. 8 is a diagram illustrating the first explanatory information FEI generated when the evaluation data ED is either the training data TD or the verification data VD. FIG. 9 is a diagram illustrating the first explanatory information FEI generated when the evaluation data ED is the abnormal data AD.

As illustrated in FIG. 8, in a first case where the evaluation data ED is either the training data TD or the verification data ED, the first explanatory information FEI includes the spectral similarity information IRSp and the data similarity information IDa. The spectral similarity information IRSp is information related to the spectral similarity RSp and is information indicating at least one of the spectral similarity RSp and a statistical representative value PRSp of the distribution of the spectral similarity RSp.

The spectral similarity RSp includes a self-class maximum spectral similarity RSp_maxA and a different-class maximum spectral similarity RSp_maxB. The self-class maximum spectral similarity RSp_maxA is a similarity indicating a maximum value among a plurality of self-class spectral similarities RSp_A. The self-class spectral similarity RSp_A is the spectral similarity RSp between the feature spectrum Sp of the evaluation data ED and a self-class known feature spectrum KSp_A which is the known feature spectrum of the same class as the evaluation class indicated by the prior label LB associated with the evaluation data ED in the known feature spectrum group KSpG. The different-class maximum spectral similarity RSp_maxB is a similarity indicating a maximum value among a plurality of different-class spectral similarities RSp_B. The different-class spectral similarity RSp_B is the spectral similarity RSp between the feature spectrum Sp of the evaluation data ED and a different-class known feature spectrum KSp_B which is the known feature spectrum of a class different from the evaluation class in the known feature spectrum group KSpG.

The distribution representative value PRSp includes a self-class spectrum representative value PRSp_A and a different-class spectrum representative value PRSp_B. The self-class spectrum representative value PRSp_A is a representative value of the distribution of the plurality of self-class spectral similarities RSp_A. The different-class spectrum representative value PRSp_B is a representative value of the distribution of the plurality of different-class spectral similarities RSp_B. A detailed method of generating the representative value PRSp will be described later.

The spectral similarity information IRSp includes self-class spectral similarity information IRSp_A related to the self-class maximum spectral similarity RSp_maxA and different-class spectral similarity information IRSp_B related to the different-class maximum spectral similarity RSp_maxB. The self-class spectral similarity information IRSp_A includes the self-class maximum spectral similarity RSp_maxA and the self-class spectral representative value PRSp_A described above. In other exemplary embodiments, the self-class spectral similarity information IRSp_A may include at least one of the self-class maximum spectral similarity RSp_maxA and the self-class spectral representative value PRSp_A. The different-class spectral similarity information IRSp_B includes the different-class maximum spectral similarity RSp_maxB and the different-class spectral representative value PRSp_B described above. In other exemplary embodiments, the different-class spectral similarity information IRSp_B may include at least one of the different-class maximum spectral similarity RSp_maxB and the different-class spectral representative value PRSp_B.

The data similarity information IDa is information related to the data similarity Da. In the present exemplary embodiment, the data similarity information IDa is information indicating the data similarity Da. The data similarity Da includes a self-class maximum data similarity Da_A and a different-class maximum data similarity Da_B. The self-class maximum data similarity Da_A is a similarity between the input data IM associated with the self-class known feature spectrum KSp_A that is a calculation source of the self-class maximum spectral similarity RSp_maxA and the evaluation data ED. The different-class maximum data similarity Da_B is a similarity between the input data IM associated with the different-class known feature spectrum KSp_B that is a calculation source of the different-class maximum spectral similarity RSp_maxB and the evaluation data ED.

The data similarity information IDa includes self-class data similarity information IDa_A and different-class data similarity information IDa_B. The self-class data similarity information IDa_A is information related to the above-described self-class maximum data similarity Da_A, and is information indicating the self-class maximum data similarity Da_A in the present exemplary embodiment. The different-class data similarity information IDa_B is information related to the above-described different-class maximum data similarity Da_B, and is information indicating the different-class maximum data similarity Da_B in the present exemplary embodiment.

As illustrated in FIG. 9, in a second case where the evaluation data ED is the abnormal data AD, since the abnormal data AD is not associated with the prior label LB, it is not possible to distinguish whether the abnormal data AD is in the same class as the known feature spectrum KSp or in a different class from the known feature spectrum KSp. Therefore, in the second case, the first explanatory information FEI includes the spectral similarity information IRSp and the data similarity information IDa which are not distinguished into the self-class and the different-class. The spectral similarity information IRSp is information related to the spectral similarity RSp and is information indicating the maximum spectral similarity RSp_max. The data similarity information IDa is information related to a maximum data similarity Da_max, and is information indicating the maximum data similarity Da_max in the present exemplary embodiment. The maximum spectral similarity RSp_max is the similarity of the maximum value among the spectral similarities RSp, obtained for each known feature spectrum KSp of the known feature spectrum group KSpG. Also in the second case, the spectral similarity information IRSp may have the representative value PRSp of the distribution. The distribution representative value PRSp is a statistical representative value of the distribution of the spectral similarity RSp, obtained for each known feature spectrum KSp.

A-3. Calculation method for the spectral similarity:

As a calculation method for the above-described spectral similarity, for example, any one of the following methods can be adopted.

(1) a first calculation method M1 for obtaining the spectral similarity RSp without considering a correspondence of the partial regions in the known feature spectrum KSp of the training data TD and in the feature spectrum Sp of the evaluation data ED.

(2) a second calculation method M2 for obtaining the spectral similarity RSp between the corresponding partial regions Rn with respect to the known feature spectrum KSp of the training data TD and the feature spectrum Sp of the evaluation data ED.

(3) a third calculation method M3 for obtaining the spectral similarity RSp without considering the partial region Rn at all.

In the following, a method of calculating the spectral similarity RSp from the output of the ConvVN2 layer 250 according to these calculation methods M1, M2, and M3 will be sequentially described.

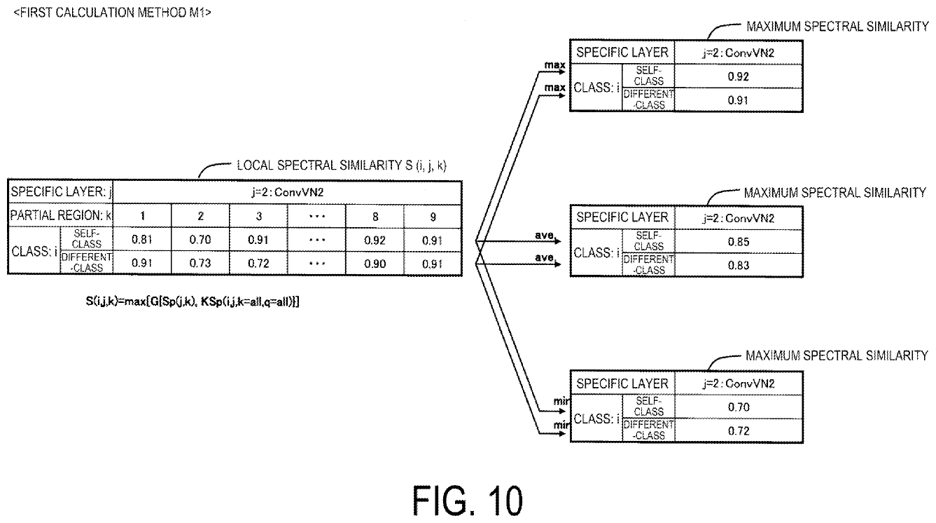

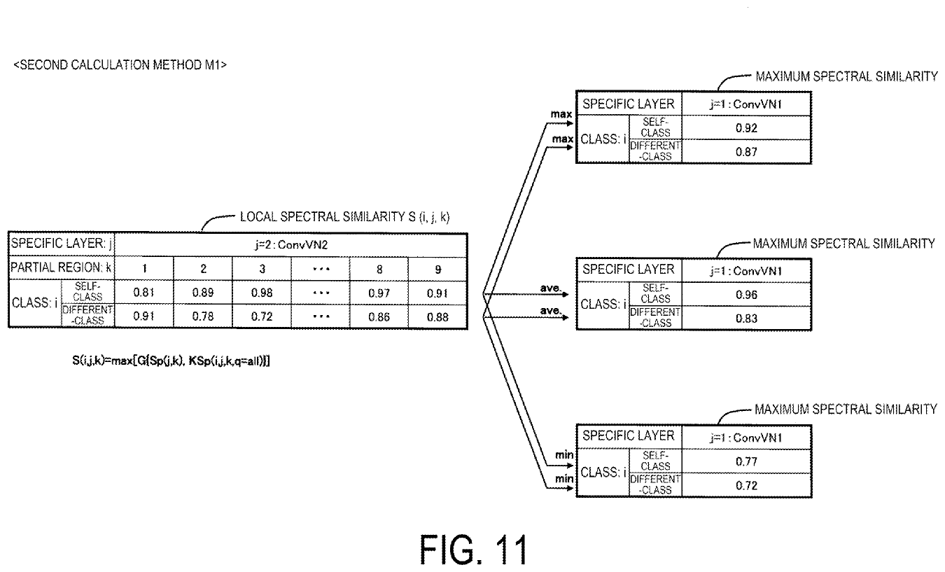

FIG. 10 is an explanatory diagram illustrating the first calculation method M1 of the maximum spectral similarity. FIG. 10 illustrates a calculation method of the maximum spectral similarity RSp_max when the evaluation data ED is either the training data TD or the verification data VD. In the first calculation method M1, first, a local spectral similarity S (i, j, k) is calculated for each partial region Rn from the output of the ConvVN2 layer 250 which is the specific layer. When the evaluation data ED is either the training data TD or the verification data VD, the local spectral similarity S (i, j, k) includes a local spectral similarity S (i, j, k) for the self-class that is the same class as the prior label LB associated with the evaluation data ED and a local spectral similarity S (i, j, k) for the different-class that is a class different from the prior label LB associated with the evaluation data ED. On the other hand, when the evaluation data ED is the abnormal data AD, the local spectral similarity S (i, j, k) for all classes is calculated. Then, one of three types of maximum spectral similarities RSp_max illustrated on the right side of FIG. 10 is calculated from these local spectral similarities S (i, j, k).

In the first calculation method M1, the local spectral similarity S (i, j, k) is calculated using the following equation.

S (i, j, k)=max [G{Sp (j, k), KSp (i, j, k=all, q=all)}] (c1)

Where

i is a parameter indicating the self-class or the different-class;

j is a parameter indicating the specific layer;

k is a parameter indicating the partial region Rn;

q is a parameter indicating the data number;

G {a, b} is a function for obtaining the spectral similarity between a and b;

Sp (j, k) is the feature spectrum obtained from the output of the specific partial region Rn of the specific layer j in accordance with the evaluation data ED;

KSp (i, j, k=all, q=all) is the known feature spectrum of the all data number q in all partial regions Rn of the specific layer j associated with a self-class i or different-class i in the known feature spectrum group KSpG illustrated in FIG. 6; and

max [X] is a logical operation taking the maximum value of the values of X.

As the function G {a, b} for obtaining the local spectral similarity, for example, an equation for obtaining the cosine similarity or an equation for obtaining the similarity according to the distance can be used. Further, when the evaluation data ED is the abnormal data AD, the above parameter i specifies all classes, so KSp (i, j, k=all, q=all) in the above equation (c1) becomes KSp (i=all, j, k=all, q=all).

The three types of maximum spectral similarities RSp_max illustrated on the right side of FIG. 10 are calculated as representative similarities by statistically processing the local spectral similarities S (i, j, k) for the plurality of partial regions Rn. As a statistical process, RSp_max is obtained by taking a maximum value, an average value, or a minimum value of a plurality of the local spectral similarities S (i, j, k). Although not illustrated, which calculation of the maximum value, the average value, or the minimum value is used is set in advance by the user experimentally or empirically.

As described above, in the first calculation method Ml of the maximum spectral similarity, the maximum spectral similarities RSp_maxA, RSp_maxB, and RSp_max are calculated by the following method.

### Self-Class Maximum Spectral Similarity RSp_maxA

(1) obtaining the local spectral similarity S (i, j, k) that is a spectral similarity between the feature spectrum Sp obtained from the output of the specific partial region Rn of the specific layer j in accordance with the evaluation data ED and all the known feature spectra KSp associated with the specific layer j and the same class as the prior label LB of the evaluation data ED, and

(2) obtaining the self-class maximum spectral similarity RSP_maxA by taking the maximum value, the average value, or the minimum value of the local spectral similarity S (i, j, k) for the plurality of partial regions Rn.

### Different-Class Maximum Spectral Similarity RSp_maxB

(1) obtaining the local spectral similarity S (i, j, k) that is a spectral similarity between the feature spectrum Sp obtained from the output of the specific partial region Rn of the specific layer j in accordance with the evaluation data ED and all the known feature spectra KSp associated with the specific layer j and a class different from the prior label LB of the evaluation data ED, and

(2) obtaining the different-class maximum spectral similarity RSP_maxB by taking the maximum value, the average value, or the minimum value of the local spectral similarity S (i, j, k) for the plurality of partial regions Rn. Maximum spectral similarity RSp_max

(1) obtaining the local spectral similarity S (i, j, k) that is a spectral similarity between the feature spectrum Sp obtained from the output of the specific partial region Rn of the specific layer j in accordance with the evaluation data ED and all the known feature spectra KSp associated with the specific layer j, and

(2) obtaining the maximum spectral similarity RSP_max by taking the maximum value, the average value, or the minimum value of the local spectral similarity S (i, j, k) for the plurality of partial regions Rn.

According to the first calculation method M1, the maximum spectral similarities RSp_max, RSp_maxA, and RSp_maxB can be obtained by a relatively simple calculation and procedure.

FIG. 11 is a diagram illustrating the second calculation method M2 of the maximum spectral similarity. FIG. 11 illustrates a calculation method of the maximum spectral similarity RSp_max when the evaluation data ED is either the training data TD or the verification data VD. The similarity calculation unit 310 calculates the local spectral similarity S (i, j, k) using the following equation instead of the above-described (c1) equation. S (i, j, k)=max [G {Sp (j, k), KSp (i, j, k, q=all)}] (c2)

Where,

KSp (i, j, k, q=all) is the known feature spectrum of the all data number q in the specific partial region Rn of the specific layer j associated with the self-class i or different-class i in the known feature spectrum group KSpG illustrated in FIG. 6. Further, as in the case of the first calculation method, when the evaluation data ED is the abnormal data AD, the above parameter i specifies all classes, so KSp (i, j, k, q=all) in the above equation (c2) becomes KSp (i=all, j, k, q=all).

In the first calculation method M1 described above, the known feature spectra KSp (i, j, k=all, q=all) in all the partial regions Rn of the specific layer j are used, whereas in the second calculation method M2, only the known feature spectra KSp (i, j, k, q=all) for the same partial region Rn as the partial region Rn of the feature spectra Sp (j, k) are used. Other methods in the second calculation method M2 are the same as those in the first calculation method M1.

As described above, in the second calculation method M2 of the maximum spectral similarity, the maximum spectral similarities RSp_maxA, RSp_maxB, and RSp_max are calculated by the following method.

### Self-class Maximum Spectral Similarity RSp_maxA

(1) obtaining the local spectral similarity S (i, j, k) that is a spectral similarity between the feature spectrum Sp obtained from the output of the specific partial region Rn of the specific layer j in accordance with the evaluation data ED and all the known feature spectra KSp associated with the specific partial region Rn of the specific layer j and the same class as the prior label LB of the evaluation data ED, and

(2) obtaining the self-class maximum spectral similarity RSP_maxA by taking the maximum value, the average value, or the minimum value of the local spectral similarity S (i, j, k) for the plurality of partial regions Rn. Different-class maximum spectral similarity RSp_maxB

(1) obtaining the local spectral similarity S (i, j, k) that is a spectral similarity between the feature spectrum Sp obtained from the output of the specific partial region Rn of the specific layer j in accordance with the evaluation data ED and all the known feature spectra KSp associated with the specific partial region Rn of the specific layer j and a class different from the prior label LB of the evaluation data ED, and

(2) obtaining the different-class maximum spectral similarity RSP_maxB by taking the maximum value, the average value, or the minimum value of the local spectral similarity S (i, j, k) for the plurality of partial regions Rn. Maximum spectral similarity RSp_max

(1) obtaining the local spectral similarity S (i, j, k) that is a spectral similarity between the feature spectrum Sp obtained from the output of the specific partial region Rn of the specific layer j in accordance with the evaluation data ED and all the known feature spectra KSp associated with the specific layer j and the specific partial region Rn, and

(2) obtaining the maximum spectral similarity RSP_max by taking the maximum value, the average value, or the minimum value of the local spectral similarity S (i, j, k) for the plurality of partial regions Rn.

According to the second calculation method M2, the maximum spectral similarities RSp_max, RSp_maxA, and RSp_maxB can be obtained by a relatively simple calculation and procedure.

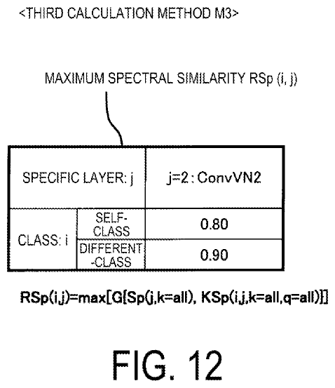

FIG. 12 is an explanatory diagram illustrating the third calculation method M3 of the maximum spectral similarity. FIG. 12 illustrates a calculation method of the maximum spectral similarity RSp_max when the evaluation data ED is either the training data TD or the verification data VD. In the third calculation method M3, the maximum spectral similarities RSp_max, RSp_maxA, and RSp_maxB are calculated from the output of the ConvVN2 layer 250, which is the specific layer, without obtaining the local spectral similarity S (i, j, k). When the maximum spectral similarities RSp_max, RSp_maxA, and RSp_maxB are used without distinction, they are referred to as the maximum spectral similarity RSp.

The maximum spectral similarity RSp (i, j) obtained by the third calculation method M3 is calculated using the following equation.

RSP (i, j)=max [G {Sp (j, k=all), KSp (i, j, k=all, q=all)}] (c3)

Where,

Sp (j, k=all) is a feature spectrum obtained from the output of all the partial regions Rn of the specific layer j in accordance with the evaluation data ED. Further, when the evaluation data ED is the abnormal data AD, the above parameter i specifies all classes, so KSp (i, j, k=all, q=all) in the above equation (c3) becomes KSp (i=all, j, k=all, q=all).

As described above, in the third calculation method M3 of the maximum spectral similarity, the maximum spectral similarities RSp_maxA, RSp_maxB, and RSp_max are calculated by the following method.

### Self-Class Maximum Spectral Similarity RSp_maxA

(1) obtaining the self-class spectral similarity RSp_A that is a similarity between all the feature spectra Sp obtained from the output of the specific layer j in accordance with the evaluation data and all the known feature spectra KSp associated with the specific layer j and the self-class i, respectively, and

(2) setting a maximum value among the plurality of self-class spectral similarities RSp_A as the self-class maximum spectral similarity RSp_maxA.

### Different-Class Maximum Spectral Similarity RSp_maxB

(1) obtaining the different-class spectral similarity RSp_B that is a similarity between all the feature spectra Sp obtained from the output of the specific layer j in accordance with the evaluation data and all the known feature spectra KSp associated with the specific layer j and the different-class i, respectively, and

(2) setting a maximum value among the plurality of different-class spectral similarities RSp_B as the different-class maximum spectral similarity RSp_maxB. Maximum spectral similarity RSp_max

(1) obtaining the spectral similarity RSp_A that is a spectral similarity between the feature spectrum Sp obtained from the output of the specific partial region Rn of the specific layer j in accordance with the evaluation data ED and all the known feature spectra KSp associated with the specific layer j, and

(2) setting a maximum value among the plurality of spectral similarities RSp as the maximum spectral similarity RSp_max.

According to the third calculation method M3, the maximum spectral similarities RSp_maxA, RSp_maxB, and RSp_max can be obtained by a simpler calculation and procedure.

A-4. For the distribution and representative value of the spectral similarities:

For example, any one of the following three methods of a first representative value calculation method MR1 to a third representative value calculation method MR3 can be adopted as a calculation method of the distribution of the spectral similarities and the representative values described above.

(1) First representative value calculation method MR1:

An individual local spectral similarity SI_max, which is a maximum value of a spectral similarity RSp between the known feature spectrum KSp obtained from one training data TD and the feature spectrum Sp of the evaluation data ED in each partial region Rn, is obtained for each of the plurality of pieces of training data TD to create a histogram as a distribution. A partial representative value that is a representative value of the histogram created for each partial region Rn is determined. As the partial representative value, a maximum value, a median value, or a mode value of the histogram can be used. In the first representative value calculation method MR1, a correspondence between the known feature spectrum KSp and the partial region Rn in the feature spectrum Sp of the evaluation data ED is considered.

Alternatively, the partial representative value may be determined by the following method. In this method, first, at least one unimodal distribution is obtained by fitting a histogram created for each partial region Rn with a mixed Gaussian distribution using an expectation-maximization algorithm (EM algorithm). When a plurality of the unimodal distributions are generated, one representative unimodal distribution is determined by using the following selection conditions C1 and C2. When one unimodal distribution is obtained, this unimodal distribution is set as the representative unimodal distribution.

Condition C1: A ratio of the area of one unimodal distribution to the entire area of the histogram of the individual local spectral similarity SI_max is equal to or greater than an area threshold.

Condition C2: A mean value of the individual local spectral similarities SI_max is the largest in the unimodal distributions satisfying the condition C1.

The area threshold in the condition C1 is set to a value of, for example, about 5 to 10%. The representative value of the representative unimodal distribution is the partial representative value of the histogram created for each partial region Rn. The representative value of the representative unimodal distribution is, for example, a mode value of the representative unimodal distribution.

Then, each partial representative value is subjected to an integration process to generate the representative value PRSp of the distribution of the spectral similarity RSp. The integration process may be, for example, a process of setting the maximum value of the plurality of partial representative values as the representative value PRSp or a process of setting the average value of the plurality of partial representative values as the representative value PRSp.

(2) Second representative value calculation method MR2:

An individual local spectral similarity SI_max, which is a maximum value of a spectral similarity RSp between the known feature spectrum KSp obtained from one training data TD and the feature spectrum Sp of the evaluation data ED in each partial region Rn, is obtained for each of the plurality of pieces of training data TD to create a histogram as a distribution. A partial representative value that is a representative value of the histogram created for each partial region Rn is determined. As the partial representative value, a maximum value, a median value, or a mode value of the histogram can be used. The second representative value calculation method MR2 is different from the first representative value calculation method MR1 in that corresponding partial regions Rn in the known feature spectrum KSp and the feature spectrum Sp of the evaluation data ED are compared with each other. As in the case of the first representative value calculation method MR1, the representative value PRSp may be determined from at least one unimodal distribution obtained by fitting with the mixed Gaussian distribution using the expectation-maximization algorithm (EM algorithm).

(3) Third representative value calculation method MR3:

Without considering the partial region Rn at all, an individual spectral similarity Sa_max, which is a maximum value of the spectral similarity between the known feature spectrum KSp obtained from one piece of training data TD and the spectral similarity RSp with the feature spectrum Sp of the evaluation data ED, is obtained for each of the plurality of pieces of training data TD to create a histogram as a distribution. The maximum value, the median value, or the mode value of the created histogram is used as the representative value PRSp. As in the case of the first representative value calculating method MR1, the representative value PRSp may be determined from at least one unimodal distribution obtained by fitting with the mixed Gaussian distribution using the expectation-maximization algorithm (EM algorithm).

In the first to third representative value calculation methods MR1 to MR3, when the evaluation data ED is the training data TD or the verification data VD, the representative value PRSp_A of the self-class spectral similarity RSp_A and the representative value PRSp_B of the different-class spectral similarity RSp_B are calculated separately for the self-class and the different-class. On the other hand, when the evaluation data ED is the abnormal data AD, the representative value PRSp is calculated without distinguishing between the self-class and the different-class.

In the first representative value calculation method MR1, the individual local spectral similarity SI_max (i, j, k, q) is calculated using the following equation.

SI_max (i, j, k, q)=max [G {Sp (j, k), KSp (i, j, k=all, q)}] (d1)

Further, when the evaluation data ED is the abnormal data AD, the above parameter i specifies all classes, so KSp (i, j, k=all, q) in the above equation (d1) becomes KSp (i=all, j, k=all, q). The individual local spectral similarity SI_max in the above equation (d1) can be calculated in the process of calculating the local spectral similarity S (i, j, k) using the first calculation method M1.

In the second representative value calculation method MR2, the individual local spectral similarity SI_max (i, j, k, q) is calculated using the following equation.

SI_max (i, j, k, q)=max [G {Sp (j, k), KSp (i, j, k, q)}] (d2)

Further, when the evaluation data ED is the abnormal data AD, the above parameter i specifies all classes, so KSp (i, j, k, q) in the above equation (d2) becomes KSp (i=all, j, k, q). The individual local spectral similarity SI_max in the above equation (d2) can be calculated in the process of calculating the local spectral similarity S (i, j, k) using the second calculation method M2.

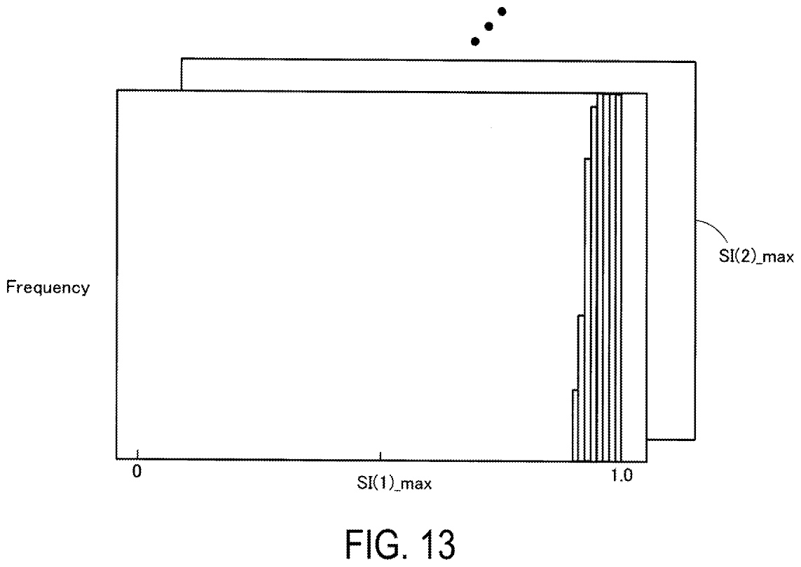

FIG. 13 is a diagram illustrating a histogram of the individual local spectral similarity SI_max. The vertical axis represents a data number, that is, a frequency, and the horizontal axis represents the individual local spectral similarity SI_max. When the evaluation data ED is the training data TD or the verification data VD, the histogram is generated for each of the self-class and the different-class, and for each partial region Rn. FIG. 13 illustrates a histogram of the self-class as an example. In FIG. 13, the number described after the reference sign SI is the number of the partial region Rn. When the specific layer is the ConvVN2 layer 250, since there are nine partial regions Rn, nine histograms are generated for each of the self-class and the different-class. Since the individual local spectral similarity SI_max (i, j, k, q) is calculated without distinguishing the self-class from the different-class when the evaluation data ED is the abnormal data AD, nine histograms corresponding to the number of the partial regions Rn are generated when the specific layer is the ConvVN2 layer 250.

For example, when the evaluation data ED is the training data TD or the verification data VD, the similarity calculation unit 310 obtains the representative value PRSp from each partial representative value calculated from the histogram corresponding to the partial region Rn for each of the self-class and the different-class.

In the third representative value calculation method MR3, the individual spectral similarity Sa_max (i, j, q) is calculated using the following equation.

Sa_max (i, j, q)=max [G {Sp (j, k=all), KSp (i, j, k=all, q)}] (d3) Further, when the evaluation data ED is the abnormal data AD, the above parameter i specifies all classes, so KSp (i, j, k=all, q) in the above equation (d3) becomes KSp (i=all, j, k=all, q). The individual spectral similarity Sa_max can be calculated in the process of calculating the spectral similarity RSp using the third calculation method M3.

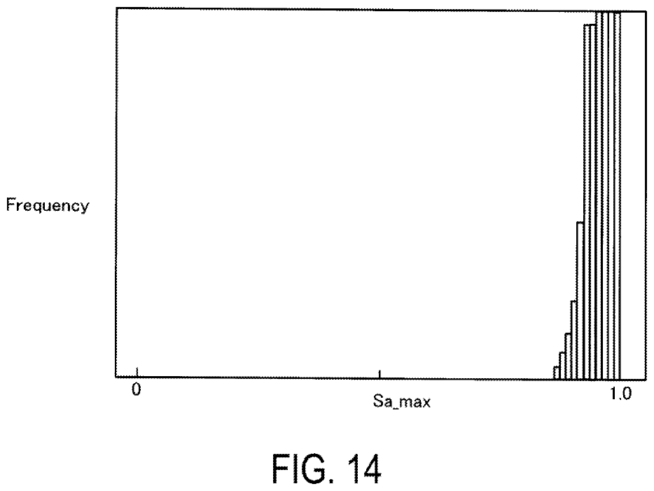

FIG. 14 is a diagram illustrating a histogram of the individual spectral similarity Sa_max. The vertical axis represents a data number, that is, a frequency, and the horizontal axis represents the individual spectral similarity Sa_max. When the evaluation data ED is the training data TD or the verification data VD, the histogram is generated for each of the self-class and the different-class. On the other hand, when the evaluation data ED is the abnormal data AD, one histogram is generated without distinguishing between the self-class and the different-class.

A-5. Data similarity calculation method:

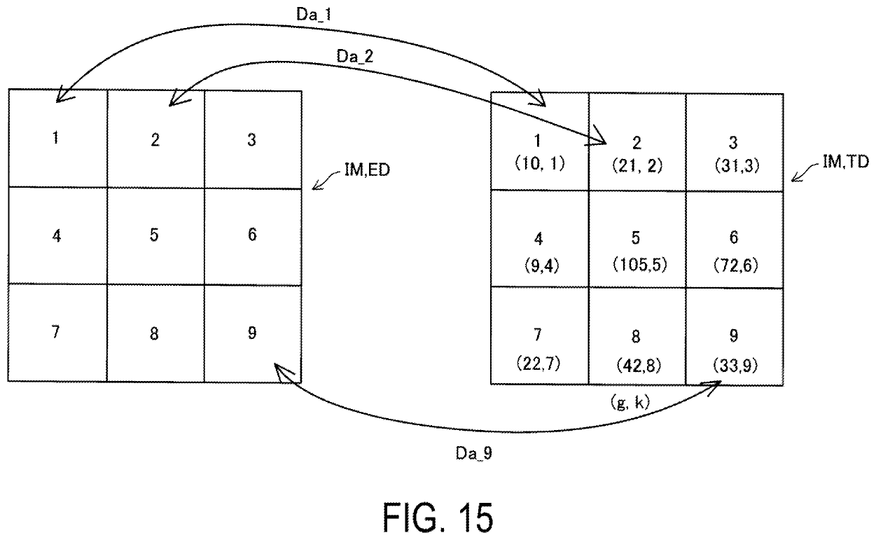

FIG. 15 is a diagram illustrating the data similarity Da. FIG. 15 is a diagram illustrating an example in which the specific layer is the ConvVN2 layer 250, and the numbers in the grids in FIG. 15 indicate the numbers of the partial regions Rn. One of the numbers in parentheses in the lattice of the training data TD indicates the data number, and the other indicates the partial region Rn. When the local spectral similarity S (i, j, k) is calculated in the first calculation method M1 or the second calculation method M2, the similarity calculation unit 310 specifies, for each partial region Rn, a training partial data that is partial data of the training data TD that is a generation source of the local spectral similarity S (i, j, k). Then, the similarity calculation unit 310 calculates, for each partial region Rn, a partial data similarity Da_k between (i) evaluation partial data that is partial data of the input data IM of the evaluation data ED and (ii) the training partial data that is corresponding partial data of the input data IM of the training data TD. “k” of the partial data similarity Da_k is a parameter indicating the partial region Rn. When there are nine partial regions Rn, nine partial data similarities Da_1 to Da_9 are calculated. To calculate the partial data similarity Da_k, for example, a cosine similarity, a mean square error (MSE), a peak S/N ratio (PSNR), or a structural similarity index measure (SSIM) is used. The similarity calculation unit 310 performs the integration process of a plurality of the calculated partial data similarities Da_k to generate the data similarity Da. For example, the similarity calculation unit 310 executes the integration process by setting the maximum value of the plurality of partial data similarities Da_k as the data similarity Da or setting the average value of the plurality of partial data similarities Da_k as the data similarity Da. Note that the similarity calculation unit 310 may generate the data similarity Da using the following method. In this method, the similarity calculation unit 310 specifies the training partial data that is partial data of the training data TD of the generation source indicating the maximum value or the minimum value of the local spectral similarity S calculated for each partial region Rn. Next, the similarity calculation unit 310 calculates the partial data similarity Da_k between the specified training partial data and the evaluation partial data that is the partial data of the input data IM of the evaluation data ED. The similarity calculation unit 310 sets the calculated partial data similarity Da_k as the data similarity Da.

As described above, the step illustrated in FIG. 7 in which the similarity calculation unit 310 generates the first explanatory information FEI includes the step of inputting the evaluation data ED to the trained machine learning model 200 to obtain the feature spectrum Sp for each partial region Rn from the output of the specific layer of the trained machine learning model 200. As illustrated in FIGS. 10 to 12, the step in which the similarity calculation unit 310 generates first explanatory information FEI includes the step of obtaining, for each of the plurality of known feature spectra KSp included in the known feature spectrum group KSpG, the similarity between the feature spectrum Sp of each partial region Rn and the known feature spectrum KSp of each partial region Rn included in the known feature spectrum group KSpG, to obtain the maximum spectral similarity RSp_max from each similarity. As illustrated in FIG. 15, the step of generating the first explanatory information FEI by the similarity calculation unit 310 includes the step of obtaining the data similarity Da from the partial data of the input data IM of the evaluation data ED and the partial data similarity Da_k of the partial data of the input data IM in the training data TD that is a calculation source of the local spectral similarity S (i, j, k) for each partial region Rn.

A-6. Detailed description of the evaluation process:

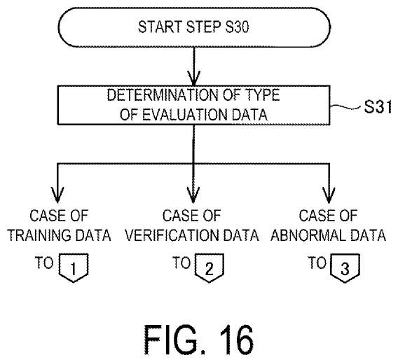

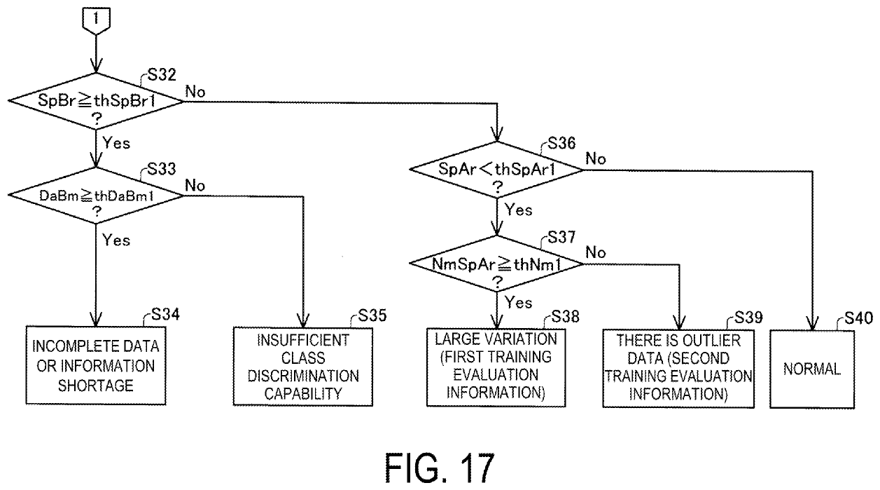

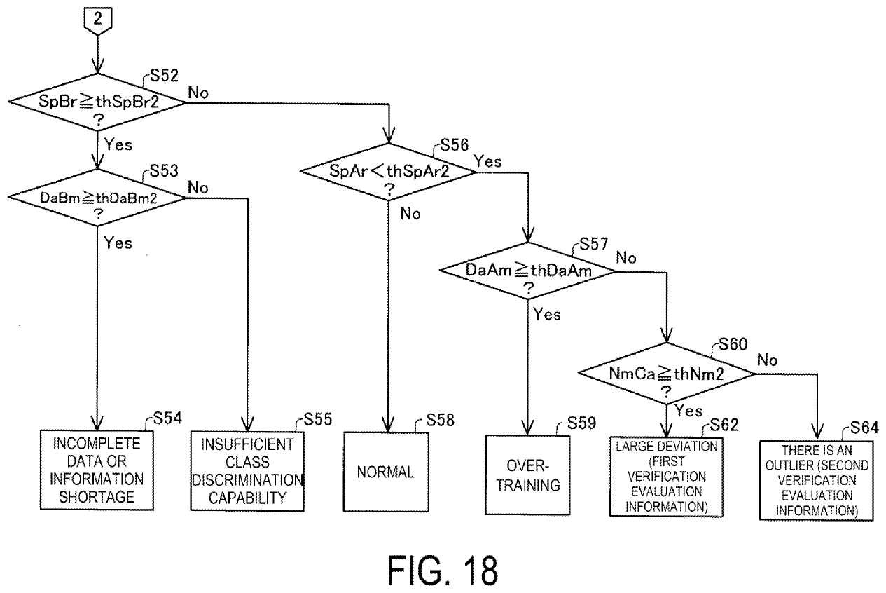

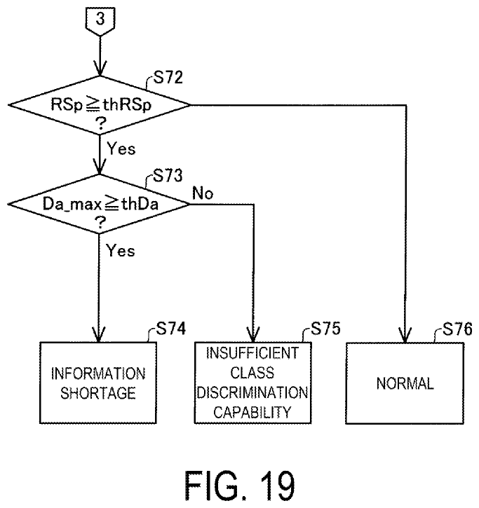

FIG. 16 is a first flowchart illustrating the details of step S30 in FIG. 7. FIG. 17 is a second flowchart illustrating the details of step S30. FIG. 18 is a third flowchart illustrating the details of step S30. FIG. 19 is a fourth flowchart illustrating the details of step S30.

As illustrated in FIG. 16, in step S31, the type of the evaluation data is determined. For example, when the processor 110 receives the type of the evaluation data ED in advance before executing the evaluation process, the evaluation unit 330 refers to the information received in advance to execute the determination of step S31. When the evaluation data ED input to the trained machine learning model 200 is added with type data indicating the type of the training data TD, the verification data VD, or the abnormal data AD, the evaluation unit 330 refers to the added type data to execute the determination in step S31.

When the evaluation data ED is the training data TD, in step S32 illustrated in FIG. 17, the evaluation unit 330 determines whether or not a value SpBr indicated by the different-class spectral similarity information IRSp_B is equal to or greater than a first different-class spectral similarity threshold thSpBr1. When the training data TD is used as the evaluation data ED, the value SpBr is, for example, the different-class spectrum representative value PRSp_B. As described above, in step S32, a first training comparison result that is a comparison result between the value SpBr indicated by the different-class spectral similarity information IRSp_B and the first different-class spectral similarity threshold thSpBr1 is generated.

When the determination result in step S32 is “Yes”, in step S33, the evaluation unit 330 determines whether or not a value DaBm indicated by the different-class data similarity information IDa_B is equal to or greater than a first different-class data similarity threshold thDaBm1. The value DaBm indicated by the different-class data similarity information IDa_B is the different-class maximum data similarity Da_B in the present exemplary embodiment. As described above, in step S33, a second training comparison result that is a comparison result between the value DaBm indicated by the different-class data similarity information IDa_B and the first different-class data similarity threshold thDaBm1 is generated.

When the determination result in step S33 is “Yes”, that is, when the value SpBr is equal to or greater than the first different-class spectral similarity threshold thSpBr1 and the value DaBm is equal to or greater than the first different-class data similarity threshold thDaBm1, it is assumed that the following event occurs. The trained machine learning model 200 determines that the evaluation input data IM that is input data of the training data TD as the evaluation data ED, and the input data IM of the training data TD having a class different from that of the evaluation data ED and having the known feature spectrum KSp similar to the feature spectrum Sp of the evaluation input data IM, are similar as data. Therefore, originally, it may be preferable that the input data IM of the different-class similar to the evaluation input data IM is classified to be the self-class. Originally, it may be preferable that the evaluation input data IM and the input data IM of the training data TD are determined not to be similar to each other as data. Therefore, in this case, in step S34, the evaluation unit 330 generates, as the second explanatory information SEI, information including at least one of a fact that there is inappropriate incomplete data in the training data TD as the plurality of pieces of evaluation data ED, and a fact that information of the training data TD as the evaluation data ED used for an evaluation is insufficient as information necessary for class discrimination. The incomplete data means data having a feature remarkably similar to normal training data of a different class. The fact that the information of the training data TD is insufficient as the information necessary for the class discrimination is assumed to be, for example, a case where the resolution of the input data IM of the training data TD is too low or a case where the input data IM is in a region different from the region necessary for the class discrimination.

When the determination result in step S33 is “No”, that is, when the value SpBr is equal to or greater than the first different-class spectral similarity threshold thSpBr1 and the value DaBm is less than the first different-class data similarity threshold thDaBm1, it is assumed that the following event occurs. When the different-class spectrum representative value PRSp_B as the value SpBr is large, it is assumed that the trained machine learning model 200 determines that the evaluation input data IM of the evaluation data ED is similar in feature to the training data TD of a different-class that is different from the class indicated by the prior label LB associated with the evaluation input data IM. On the other hand, the fact that the different-class maximum data similarity Da_B, which is the value DaBm, is low, means that the evaluation input data IM and the input data IM of the different-class training data TD determined to have similar feature by the trained machine learning model 200 are not similar in terms of data in terms of an index for calculating data similarity such as a mean square error (MSE). In this case, it is considered that the trained machine learning model 200 may not be able to correctly perform class discrimination of the evaluation data ED. Therefore, in step S35, the evaluation unit 330 generates, as the second explanatory information SEI, information indicating that there is a possibility that the machine learning model 200 lacks capability of correctly performing class discrimination of the evaluation data ED.

In step S34 and step S35, the secondary explanatory information SEI is generated by using the first training comparison result generated in step S32 and the second training comparison result generated in step S33. Note that step S34 and step S35 may be executed regardless of the number of pieces of the evaluation data ED satisfying the condition, or may be executed when the number of pieces of the evaluation data ED satisfying the condition is equal to or greater than a predetermined threshold.

When the determination result in step S32 is “No”, in step S36, the evaluation unit 330 determines whether or not a value SpAr indicated by the self-class spectral similarity information IRSp_A is less than a first self-class spectral similarity threshold thSpAr1. In the present exemplary embodiment, the value SpAr is the self-class spectrum representative value PRSp_A. The evaluation unit 330 executes step S36 for each of the plurality of pieces of evaluation data ED, and counts a number NmSpAr of pieces of the evaluation data ED satisfying the condition that the value SpAr is less than the first self-class spectral similarity threshold thSpAr1. Next, in step S37, the evaluation unit 330 determines whether or not the number NmSpAr is equal to or greater than a predetermined first data-threshold thNm1. When the determination result in step S37 is “Yes”, it is assumed that the following event occurs. That is, when the number of pieces of evaluation data ED satisfying the condition is large, it is assumed that the machine learning model 200 determines that the features of the evaluation input data IM and the input data IM of the training data group TDG of the same class as the class indicated by the prior label LB associated with the evaluation input data IM are not similar to each other. Therefore, in this case, there is a possibility that the features of a large number of pieces of the evaluation input data IM are deviated from the features of the input data IM of the other training data TD belonging to the same class. Therefore, in step S38, the evaluation unit 330 generates first training evaluation information indicating that there is a large variation between the features of the plurality of pieces of input data IM included in the plurality of pieces of training data TD used as the evaluation data ED.

When the determination result in step S37 is “No”, step S39 is executed. That is, when the number of pieces of evaluation data ED satisfying the condition is small, the evaluation unit 330 generates, as the second explanatory information SEI, second training evaluation information indicating that there is outlier data in the plurality of pieces of input data IM included in the plurality of pieces of training data TD used as the evaluation data ED. The outlier data means data having characteristics significantly different from those of a set of normal training data in general.

When the determination result in step S36 is “No” for each evaluation data ED, in step S40, the evaluation unit 330 generates, as the second explanatory information SEI, information indicating that the evaluation of the machine learning model 200 is normal.

As illustrated in FIG. 18, when the evaluation data ED is the verification data VD, in step S52, the evaluation unit 330 determines whether or not a value SpBr indicated by the different-class spectral similarity information IRSp_B is equal to or greater than a second different-class spectral similarity threshold thSpBr2. When the verification data VD is used as the evaluation data ED, the value SpBr is, for example, the different-class maximum spectral similarity RSp_maxB. As described above, in step S52, a first verification comparison result that is the comparison result between the value SpBr indicated by the different-class spectral similarity information IRSp_B and the second different-class spectral similarity threshold thSpBr2 is generated. The second different-class spectral similarity threshold thSpBr2 may be the same as or different from the first different-class spectral similarity threshold thSpBr1.

When the determination result in step S52 is “Yes”, in step S53, the evaluation unit 330 determines whether or not a value DaBm indicated by the different-class data similarity information IDa_B is equal to or greater than a second different-class data similarity threshold thDaBm2, as in step S33. In step S53, a second verification comparison result that is a comparison result between the value DaBm indicated by the different-class data similarity information IDa_B and the different-class data similarity threshold thDaBm is generated. The second different-class data similarity threshold thDaBm2 may be the same as or different from the first different-class data similarity threshold thDaBm1.

When the determination result in step S53 is “Yes”, that is, when the value SpBr is equal to or greater than the second different-class spectral similarity threshold thSpBr2 and the value DaBm is equal to or greater than the second different-class data similarity threshold thDaBm2, it is assumed that an event similar to the case where the evaluation-data ED is the training data TD has occurred. Therefore, in step S54, the evaluation unit 330 generates, as the second explanatory information SEI, information including at least one of a fact that there is inappropriate incomplete data in the plurality of pieces of verification data ED, and a fact that information of the verification data ED is insufficient as information necessary for class discrimination.

When the determination result in step S53 is “No”, that is, when the value SpBr is equal to or greater than the second different-class spectral similarity threshold thSpBr2 and the value DaBm is less than the second different-class data similarity threshold thDaBm2, it is assumed that an event similar to the case where the evaluation-data ED is the training data TD has occurred. Therefore, in step S55, the evaluation unit 330 generates, as the second explanatory information SEI, information indicating that there is a possibility that the machine learning model 200 lacks capability of correctly performing class discrimination of the verification data VD that is the evaluation data ED.

In step S54 and step S55, the secondary explanatory information SEI is generated using the first verification comparison result generated in step S52 and the second verification comparison result generated in step S53. Note that step S54 and step S55 may be executed regardless of the number of pieces of the evaluation data ED satisfying the condition, or may be executed when the number of pieces of the evaluation data ED satisfying the condition is equal to or greater than a predetermined threshold.

When the determination result in step S52 is “No”, in step S56, the evaluation unit 330 determines whether or not the value SpAr indicated by the self-class spectral similarity information IRSp_A is less than a second self-class spectral similarity threshold thSpAr2. When the verification data VD is used as the evaluation data ED, the value SpAr is, for example, the self-class maximum spectral similarity RSp_maxA. When the determination result in step S56 is “No” for all the evaluation data ED, in step S58, the evaluation unit 330 generates information indicating that the evaluation of the machine learning model 200 is normal as the second explanatory information SEI. The second self-class spectral similarity threshold thSpAr2 may be the same as or different from the first self-class spectral similarity threshold thSpAr1.

When the determination result in step S56 is “Yes”, in step S57, the evaluation unit 330 determines whether or not the value DaAm indicated by the self-class data similarity information IDa_A is equal to or greater than a self-class data similarity threshold thDaAm. The value DaAm indicated by the self-class data similarity information IDa_A is the self-class maximum data similarity Da_A in the present exemplary embodiment. When the determination result in step S57 is “Yes” in each the evaluation data ED, that is, when the value SpAr indicated by the self-class spectral similarity information IRSp_A is less than the second self-class spectral similarity threshold thSpAr2 and the value DaAm indicated by the self-class data similarity information IDa_A is equal to or greater than the self-class data similarity threshold thDaAm, it is assumed that the following events have occurred. In other words, the machine learning model 200 determines that the feature of the evaluation input data IM which is the input data of the verification data VD is not similar to the feature of the input data IM of the training data TD of the same self-class as the class indicated by the prior class LB of the verification data VD. On the other hand, the input data IM of the evaluation input data IM and the evaluation input data IM, which are determined to have the most similar feature by the trained machine learning model 200, are similar as data in the index for calculating the similarity of data such as the mean square error (MSE). As described above, the machine learning model 200 may determine that even the evaluation input data IM similar to the input data IM used for training is in a different class if it is not used for training. Therefore, in step S59, the evaluation unit 330 generates information indicating that over-training of the machine learning model 200 occurs as the second explanatory information SEI.

When the determination result in step S57 is “No”, the evaluation unit 330 executes step S56 and step S57 for each of the plurality of pieces of evaluation data ED, and counts a number NmCa of pieces of evaluation data ED satisfying the conditions that the value SpAr is less than the second self-class spectral similarity threshold thSpAr2 and the value DaAm is less than the self-class data similarity threshold thDaAm. Next, in step S60, the evaluation unit 330 determines whether or not the number NmCa is equal to or greater than a predetermined second data-threshold thNm2. When “Yes” in step S60, i.e. when the number NmCa is equal to or greater than the predetermined second data-threshold thNm2, it is assumed that the following events have occurred. In other words, the machine learning model 200 determines that the feature of many pieces of evaluation input data IM is not similar to the feature of the input data IM of the training data TD of the same self-class as the class indicated by the prior class LB of the verification data VD. In addition, the machine learning model 200 determines that the evaluation input data IM and the input data IM determined to be most similar as a feature are not similar to each other in terms of data similarity. When the number of pieces of verification data VD for which the above-described determination has been performed is large, it is assumed that there is a large difference in feature between the evaluation input data IM of the verification data VD and the input data IM of the training data TD. Therefore, in step S62, the evaluation unit 330 generates, as the second explanatory information SEI, the first verification evaluation information indicating that there is a large difference in feature between each evaluation input data IM as each input data included in the plurality of pieces of verification data and the input data IM included in the training data TD.

When “No” in step S60, i.e. when the number NmCa is less than the predetermined second data-threshold thNm2, it is assumed that the following events have occurred. That is, it is assumed that there is the outlier data in the plurality of pieces of input data IM included in the plurality of pieces of verification data VD. Therefore, in step S64, the evaluation unit 330 generates, as the second explanatory information SEI, second verification evaluation information indicating that there is the outlier data in the plurality of pieces of input data IM included in the plurality of pieces of verification data VD.

When the evaluation data ED illustrated in FIG. 18 is the verification data VD, the value SpAr indicated by the self-class spectral similarity information IRSp_A and the value SpBr indicated by the different-class spectral similarity information IRSp_B may be the self-class spectral representative value PRSp_A and the different-class spectral representative value PRSp_B, respectively.

As illustrated in FIG. 19, when the evaluation data ED is the abnormal data AD, in step S72, the evaluation unit 330 determines whether or not the maximum spectral similarity RSp is equal to or greater than a predetermined abnormal spectral threshold thRSp. When the determination result in step S72 is “No”, in step S76, the evaluation unit 330 generates information indicating that the evaluation of the machine learning model 200 is normal as the second explanatory information SEI.

When the determination result in step S72 is “Yes”, the evaluation unit 330 determines whether or not the maximum data similarity Da_max is equal to or greater than a predetermined abnormal-data similarity threshold thDa. When the determination result in step S73 is “Yes”, that is, when the maximum spectral similarity RSp_max is equal to or greater than the abnormal spectral threshold thRSp and the maximum data similarity Da_max is equal to or greater than the abnormal-data similarity threshold thDa, it is assumed that the following events have occurred. That is, when the evaluation data ED is the abnormal data AD, it is expected that the maximum data similarity Da_max is low. However, when the maximum data similarity Da_max is equal to or greater than the abnormal data similarity threshold thDa, it means that the abnormal data AD does not have information indicating abnormality. Therefore, in step S74, the evaluation unit 330 generates, as the second explanatory information SEI, information indicating that information of the abnormal data AD is insufficient as information necessary for class discrimination.

When the determination result in step S73 is “No”, that is, when the maximum spectral similarity RSp_max is equal to or greater than the abnormal spectral threshold thRSp and the maximum data similarity Da_max is less than the abnormal-data similarity threshold thDa, it is assumed that the following events have occurred. That is, the same event occurs as step S35 is executed in the case where the evaluation data ED is the training data TD or as step S55 is executed in the case where the evaluation data ED is the verification data VD. Therefore, in step S75, the evaluation unit 330 generates, as the second explanatory information, information indicating that there is a possibility that the machine learning model 200 lacks capability of correctly performing class discrimination of the abnormal data AD, that is, the capability of discriminating an unknown-class.

The various thresholds used in the evaluation process described above with reference to FIGS. 16 to 19 may be set by the user or may be set in advance. The various thresholds may be determined using indices of various histograms as the various distributions described above, for example, standard deviations σ, ±2 σ, or ±3 σ. This standard deviation σ may be a standard deviation of the representative unimodal distribution specified by the EM algorithm.

A-7. Addressing method:

An addressing method for the generated secondary explanatory information SEI will be described below. When step S35 and step S55 are executed and information indicating that there is a possibility that the machine learning model 200 cannot correctly perform class discrimination of the evaluation data ED is generated as the second explanatory information SEI, the following addressing method may be taken.

### Addressing Method 1A

The network configuration of the machine learning model 200 is reviewed.

In the addressing method 1A, for example, the network configuration is reviewed by increasing the number of vector neuron layers. In the addressing method 1A, for example, the number of layers of the network of the machine learning model 200 is increased, or the specific layer from which the feature spectrum Sp is acquired is changed.

When step S75 is executed and information indicating that there is a possibility that the machine learning model 200 cannot correctly perform class discrimination of the evaluation data ED is generated as the second explanatory information SEI, the following addressing method may be taken.

### Addressing Method 1B

The machine learning model 200 is trained by correcting the training data TD to training data more suitable for training for class discrimination.

In the addressing method 1B, for example, the input data IM of the training data TD is subjected to data processing for deleting elements indicating simple features. Further, for example, the prior label LB is further subdivided and associated with the input data IM. Note that the addressing method 1B may include the same addressing method as the addressing method 1A.

When step S59 is executed and information indicating that the over-training of the machine learning model 200 occurs is generated, the following addressing method may be taken.

### Addressing Method 1C

The training parameter of the machine learning model 200 is reviewed.

In the addressing method 1C, for example, the number of epochs is reduced, or the batch size in mini-batch training is reduced.

When information indicating that the information of the evaluation data ED is insufficient as information necessary for class discrimination is generated at step S34, step S54, or step S74, the following addressing methods may be taken.

### Addressing Method 1D

The data resolution of the input data IM is changed.

For example, the data resolution of a characteristic region for class discrimination is increased.

### Addressing Method 1E

Pre-processing such as average difference is introduced to original data of data IM for input.

### Addressing Method 1F

The acquisition condition of the input data IM is reviewed.

For example, the distance between the target object and the imaging device is changed, or the target object is irradiated with light.

When information indicating that there is incomplete data among the plurality of pieces of evaluation data ED is generated in step S34 or step S54, the following addressing methods may be taken.

### Addressing Method 1G

The prior label LB of the training data TD is reviewed.

For example, when a different prior label LB is associated with the plurality of pieces of input data IM having similar feature, the same prior label LB is newly associated with the plurality of pieces of input data IM.

### Addressing Method 1H

The training data TD is reduced.

For example, when a different prior label LB is associated with the plurality of pieces of input data IM having similar feature, only the input data IM associated with one prior label LB is left, and the remaining pieces of input data IM are deleted.

When information indicating that there is outlier data is generated in step S39 or step S64, the following addressing methods may be taken.

### Addressing Method 1I

The training data TD is extended.

For example, the input data IM having a feature close to the outlier data is added as the training data TD.

### Addressing Method 1J

The outlier data is deleted from the training data TD.

### Addressing Method 1K

Pre-processing is executed on the training data TD and the verification data VD.

Examples of the pre-processing include a smoothing process and a normalization process when it is assumed that there is outlier data due to noise.

When the first training evaluation information is generated in step S38, the following addressing methods may be taken.

### Addressing Method 1L

The training data TD is extended.

For example, the input data IM for reducing the variation is newly added as the training data TD.

### Addressing Method 1M

The input data IM causing the increase in the variation is deleted from the training data TD.

### Addressing Method 1N

Pre-processing is executed on the training data TD.

Examples of the pre-processing include the smoothing process and normalization process when it is assumed that the variation is large due to noise.

In step S62, when the first verification evaluation information is generated, the following addressing methods may be taken.

### Addressing Method 1O

The training data TD is extended.

The training data TD is newly added so that the deviation of the feature between each evaluation input data IM and the input data IM included in the training data TD becomes small.

### Addressing Method 1P

Pre-processing is executed on the training data TD.

Examples of the pre-processing include the smoothing process and normalization process.

In step S74, when information indicating that the information of the abnormal data AD is insufficient as the information necessary for class discrimination is generated, the following addressing method may be taken.

### Addressing Method 1Q

The specific layer is changed.

For example, when a feature that affects the class discrimination appears in a fine shape, a lower layer is set as the specific layer. For example, the specific layer is changed from the ConvVN2 layer 250 to the ConvVN1 layer 240.

The evaluation unit 330 may display the contents of the addressing methods 1A to 1K described above on the display unit 150. Accordingly, it is possible to easily grasp the addressing method regardless of the experience of the user.

A-8. Specific examples of the addressing method:

A-8-1. First specific example:

The plurality of pieces of training data TD are input as the evaluation data ED to the trained machine learning model 200, and class discrimination is executed using an activation value corresponding to a determination value of each class output from the ClassVN layer 260. As a result, a correct answer rate of the class discrimination is lower than the desired value. In this example, the ClassVN layer 260 is set as the specific layer. The evaluation unit 330 generates the secondary explanatory information SEI using the first explanatory information FEI. In this case, as the second explanatory information SEI, information indicating that there is a possibility that the machine learning model 200 cannot correctly perform class discrimination of the training data TD as the evaluation data ED is generated in step S55 illustrated in FIG. 18. Therefore, the number of vector neurons of the machine learning model 200 is increased, and training of the machine learning model 200 is executed again. As a result, the percentage of the correct answer rate is higher than the desired value.

A-8-2. Second specific example:

The plurality of pieces of verification data VD are input as the evaluation data ED to the trained machine learning model 200, and class discrimination is executed using an activation value corresponding to a determination value of each class output from the ClassVN layer 260. As a result, the correct answer rate of the class discrimination is lower than the desired value. In this example, the ClassVN layer 260 is set as the specific layer. The evaluation unit 330 generates the secondary explanatory information SEI using the first explanatory information FEI. In this case, the first verification evaluation information is generated in step S62 illustrated in FIG. 18. As a result of analyzing the training data TD and the verification data VD based on the second explanatory information SEI, it is confirmed that the verification data VD has a characteristic different from that of the training data TD. Specifically, it is found that the input data IM of the verification data VD includes noise due to a difference in setting of a device for acquiring the input data IM of the training data TD and the verification data VD. Therefore, the smoothing process is executed as pre-processing on the input data IM of the verification data VD. As a result of inputting the verification data VD after execution of the smoothing process to the machine learning model 200 and executing the evaluation process, information indicating normality is generated as the second explanatory information. Therefore, as a result of calculating the correct answer rate of the class discrimination of the machine learning model 200 using the verification data VD after execution of the smoothing process, the correct answer rate exceeds the desired value.

A-8-3. Third specific example:

The abnormal data AD expected to be class-discriminated as an unknown-class is input as the evaluation data ED to the trained machine learning model 200, and the evaluation process is executed. The class discrimination is executed using an activation value corresponding to a determination value of each class output from the ClassVN layer 260. In this example, the ClassVN layer 260 is set as the specific layer. The evaluation unit 330 generates the secondary explanatory information SEI using the first explanatory information FEI. In this case, as the second explanatory information SEI, information indicating that the information of the abnormal data AD is insufficient as information necessary for class discrimination is generated in step S74 illustrated in FIG. 19. As a result of analyzing the abnormal data AD based on this information, it has been found that the region of the data representing the variant portion of the target object, which is the cause of the class discrimination to be the unknown-class, is relatively smaller than the region indicated by the abnormal data AD. Therefore, the specific layer used for generating the first explanatory information FEI is changed from the ClassVN layer 260 to the ConvVN2 layer 250. After the change of the specific layer, the first explanatory information FEI is generated based on the output of the ConvVN2 layer 250, and the second explanatory information SEI is generated from the first explanatory information FEI. In this case, the secondary explanatory information SEI indicates “normal”. In addition, a class correct answer rate, which is a rate at which the plurality of pieces of abnormal data AD are class-discriminated as the unknown-class, also increases. Note that the spectral similarity RSp may be used to evaluate the class correct answer rate. In this case, when the layer for generating the first explanatory information FEI is changed, the calculated class correct answer rate may also change. In this case, it is preferable to input the training data TD and the verification data VD to the machine learning model 200 to check again whether the class correct answer rate is equal to or higher than the desired value.

A-9. Calculation method for an output vector of each layer of the machine learning model:

A calculation method of the output of each layer in the machine learning model 200 illustrated in FIG. 2 is as follows.

Each node of the PrimeVN layer 230 regards the scalar outputs of the 1×1×32 nodes of the Conv layer 220 as a 32-dimensional vector, and multiplies this vector by a transformation matrix to obtain vector outputs of the node. The transformation matrix is an element of a kernel having a surface size of 1×1 and is updated by training of the machine learning model 200. It is also possible to integrate the processes of the Conv layer 220 and the PrimeVN layer 230 into one primary vector neuron layer.

When the PrimeVN layer 230 is referred to as a “lower layer L” and the ConvVN1 layer 240 adjacent to the upper side thereof is referred to as an “upper layer L+1”, the output of each node of the upper layer L+1 is determined using the following equation.

$$[ Mathematical Equation 1 ]$$

$$[ Math 1 ]$$

$${ν}_{i j} = {W}_{i j}^{L} {M}_{i}^{L} \qquad ( E1 )$$

$${u}_{j} = {\sum }_{i} {v}_{i j} \qquad ( E2 )$$

$${a}_{j} = F ( ‖ {u}_{j} ‖ ) \qquad ( E3 )$$

$${M}_{j}^{L + 1} = {a}_{j} \times \frac{1}{‖ {u}_{j} ‖} {u}_{j} \qquad ( E4 )$$

Where

M^{L}ᵢ is an output vector of the i-th node in the lower layer L;

M^{L+1}ⱼ is an output vector of the j-th node in the upper layer L+1;

vᵢⱼ is a prediction vector of the output vector M^{L+1}ⱼ;

W^{L}ᵢⱼ is a prediction matrix for calculating the prediction vector vᵢⱼ from the output vector M^{L}ᵢ of the lower layer L;

uⱼ is a sum vector which is the sum, i.e., linear combination, of the prediction vectors vᵢⱼ;

aⱼ is an activation value which is a normalization coefficient obtained by normalizing a norm |uⱼ| of the sum vector uⱼ; and

F (X) is a normalization function for normalizing X.

As the normalizing function F (X), for example, the following equation (E3a) or equation (E3b) can be used.

$$[ Mathematical Equation 2 ]$$

$$[ Math 2 ]$$

$${a}_{j} = F ( ‖ {u}_{j} ‖ ) = softmax ( ‖ {u}_{j} ‖ ) = \frac{exp ( β ‖ {u}_{j} ‖ )}{{\sum }_{k} exp ( β ‖ {u}_{k} ‖ )} \qquad ( E3a )$$

$${a}_{j} = F ( ‖ {u}_{j} ‖ ) = \frac{( ‖ {u}_{j} ‖ )}{{\sum }_{k} ( ‖ {u}_{k} ‖ )} \qquad ( E3b )$$

Where,

k is an ordinal number for all nodes of the upper layer L+1; and

β is an adjustment parameter which is an arbitrary positive coefficient, for example, β=1.

In the above equation (E3a), the activation value aⱼ is obtained by normalizing the norm |uⱼ| of the sum vector uⱼ with respect to all nodes of the upper layer L+1 by the softmax function. On the other hand, in the (E3b) equation, the activation value aⱼ is obtained by dividing the norm |uⱼ| of the sum vector uⱼ by the sum of the norms |uⱼ| of all the nodes of the upper layer L+1. As the normalizing function F (X), the (E3a) equation or a function other than the (E3b) equation may be used.

The ordinal number i in the above equation (E2) is conveniently assigned to a node in the lower layer L used to determine the output vector M^{L+1}ⱼ of the j-th node in the upper layer L+1, and takes a value of 1 to n. An integer n is the number of nodes in the lower layer L used to determine the output vector M^{L+1}ⱼ of the j-th node in the upper layer L+1. Thus, the integer n is given by:

N=Nk×Nc (E5)

Where, Nk is a surface size of the kernel, and Nc is a number of channels of the PrimeVN layer 230, which is the lower layer. In the example of FIG. 2, Nk=9 and Nc=16, therefore n=144.

One kernel used to obtain the output vector of the ConvVN1 layer 240 has 3×3×16=144 elements with a kernel size of 3×3 and a depth of 16 channels in the lower layer, and each of these elements is a prediction matrix W^{L}ᵢⱼ. Also, 12 sets of these kernels are required to generate output vectors for the 12 channels of the ConvVN1 layer 240. Therefore, the number of prediction matrices W^{L}ᵢⱼ of the kernel used to obtain the vectors outputted from the ConvVN1 layer 240 is 144×12=1728. These prediction matrices W^{L}ᵢⱼ are updated by training of the machine learning model 200.

As can be seen from the above-described (E1) to (E4) equations, the output vectors M^{L+1}ⱼ of the individual nodes of the upper layer L+1 are obtained by the following calculations.

(a) An output vector M^{L}ᵢ of each node of the lower layer L is multiplied by a prediction matrix W^{L}ᵢⱼ to obtain a prediction vector vᵢⱼ;

(b) A sum vector uⱼ of the prediction vectors vᵢⱼ obtained from each node of the lower layer L, i.e. a linear combination, is obtained;

(c) A norm |uⱼ| of the sum vector uⱼ is normalized to obtain an activation value aⱼ; and

(d) The sum vector uⱼ is divided by the norm |uⱼ| and further multiplied by the activation value aⱼ.

The activation value aⱼ is a normalization coefficient obtained by normalizing the norm |uⱼ| for all the nodes in the upper layer L+1. Therefore, the activation value aⱼ can be considered as an index indicating the relative output intensity of each node among all nodes in the upper layer L+1. The norm used in equations (E3), (E3a), (E3b), and (4) is typically the L2 norm representing the vector length. In this case, the activation value aⱼ corresponds to the vector length of the output vector M^{L+1}ⱼ. Since the activation value aⱼ is only used in the above-described (E3) equation and (E4) equation, it does not need to be output from the node. However, the upper layer L+1 can also be configured to output the activation value aⱼ to the outside.

The configuration of the vector neural network is substantially the same as the configuration of the capsule network, and the vector neuron of the vector neural network correspond to the capsule of the capsule network. However, the calculation by the above-described equations (E1) to (E4) used in the vector neural network is different from the calculation used in the capsule network. The most significant difference therebetween is that, in the capsule network, the prediction vector vᵢⱼ on the right side of the above equation (E2) is each multiplied by a weight, and the weight is searched by repeating dynamic routing a plurality of times. On the other hand, in the vector neural network of the present exemplary embodiment, since the output vector M^{L+1}ⱼ is obtained by sequentially calculating the above-described equations (E1) to (E4) once, there is no need to repeat the dynamic routing, and there is an advantage that the calculation is faster. In addition, the vector neural network of the present exemplary embodiment has an advantage that a memory amount required for calculation is less than that of the capsule network, and according to an experiment of the inventor of the present disclosure, the required memory amount is only about ½ to ⅓.

The vector neural network is the same as the capsule network in that it uses nodes that input and output vectors. Thus, the advantages of using vector neurons are in common with capsule networks. In addition, the plurality of layers 210 to 250 are the same as the ordinary convolutional neural network in that a higher layer expresses a feature of a greater region and a lower layer expresses a feature of a smaller region. Here, the “feature” means a characteristic portion included in input data to the neural network. Vector neural networks and capsule networks are superior to ordinary convolutional neural networks in that the output vector of a certain node contains spatial information representing the spatial information of the feature expressed by that node. That is, the vector length of an output vector of a certain node represents the existence probability of a feature expressed by the node, and the vector direction represents the spatial information such as the direction and scale of the feature. Therefore, the vector directions of the output vectors of two nodes belonging to the same layer represent the positional relationship of the respective features. Alternatively, the vector direction of the output vector of the two nodes represents the variation of the feature. For example, for a node corresponding to an “eye” feature, the direction of the output vector may represent variations in the thinness of the eye, how it is lifted, etc. In the ordinary convolutional neural network, it is said that spatial information of a feature is lost by a pooling process. As a result, the vector neural network and the capsule network have an advantage that they are excellent in the performance of identifying input data as compared with the ordinary convolutional neural network.

The advantage of the vector neural network can be considered as follows. That is, in a vector neural network, it is advantageous that the output vector of the node expresses the feature of the input data as coordinates in a continuous space. Therefore, the output vector can be evaluated such that if the vector directions are close to each other, the features are similar. In addition, even when a feature included in input data cannot be covered by supervised data, the feature can be discriminated by interpolation. On the other hand, the ordinary convolutional neural network has a drawback in that the feature of input data cannot be expressed as coordinates in a continuous space because random compression is applied by the pooling processing.

Since the output of each node of the ConvVN2 layer 250 and the ClassVN layer 260 is determined in the same manner using the above-described (E1) to (E4) equations, a detailed description thereof will be omitted. The resolution of the ClassVN layer 260, which is the uppermost layer, is 1×1, and the channel number thereof is M.

The output of the ClassVN layer 260 is converted into a plurality of determination values Class1 to Class2 for a known class. These determination values are normally values normalized by the softmax function. Specifically, for example, the determination value for each class can be obtained by calculating a vector length of the output vector from the output vector of each node of the ClassVN layer 260, and further normalizing the vector length of each node by the softmax function. As described above, the activation value aⱼ obtained by the above equation (E3) is a value corresponding to the vector length of the output vector M^{L+1}ⱼ and is normalized. Therefore, the activation value aⱼ in each node of the ClassVN layer 260 may be output and used as it is as the determination value for each class.

In the above-described exemplary embodiment, as the machine learning model 200, a vector neural network that obtains an output vector by calculation of the above-described (E1) equation to (E4) equation is used. However, instead of this, the capsule network disclosed in U.S. Pat. No. 5,210,798 or WO 2009/083553 may be used.

According to the above-described exemplary embodiment, it is possible to generate and output the second explanatory information SEI indicating the evaluation of the trained machine learning model 200 using the first explanatory information FEI including the spectral similarity information IRSp and the data similarity information IDa. Accordingly, it is possible to evaluate the trained machine learning model without causing a difference between users. In addition, based on the evaluation of the machine learning model 200, it is possible to efficiently improve the machine learning model 200, such as increasing the correct answer rate.

B. Other Aspects:

The present disclosure is not limited to the embodiments described above, and may be implemented in various aspects without departing from the spirits of the disclosure. For example, the present disclosure can be realized by the following aspects. Appropriate replacements or combinations may be made to the technical features in the above-described embodiments which correspond to the technical features in the aspects described below to solve some or all of the problems of the disclosure or to achieve some or all of the advantageous effects of the disclosure. Additionally, when the technical features are not described herein as essential technical features, such technical features may be deleted appropriately.

(1) According to a first aspect of the present disclosure, there is provided an evaluation method for a trained machine learning model. The machine learning model is a vector neural network model including a plurality of vector neuron layers, and is trained by using a plurality of pieces of training data including input data and a prior label associated with the input data. The evaluation method includes the steps of (a) inputting evaluation data to the trained machine learning model to generate first explanatory information used for an evaluation of the machine learning model, (b) using a value indicated by each piece of information included in the first explanatory information to generate second explanatory information indicating an evaluation of the trained machine learning model, and (c) outputting the generated second explanatory information, wherein the step (a) includes the steps of (a1) inputting the evaluation data to the trained machine learning model to obtain a feature spectrum from an output of a specific layer of the trained machine learning model, (a2) obtaining a spectral similarity that is a similarity between the feature spectrum and a known feature spectrum included in a known feature spectrum group obtained from an output of the specific layer by inputting the plurality of pieces of training data to the trained machine learning model again, for each of a plurality of the known feature spectra included in the known feature spectrum group, (a3) obtaining a data similarity that is a similarity between the input data and the evaluation data, and (a4) generating the first explanatory information including spectral similarity information related to the spectral similarity and data similarity information related to the data similarity. According to this aspect, it is possible to generate and output the second explanatory information indicating the evaluation of the trained machine learning model using the first explanatory information including the spectral similarity information and the data similarity information. Therefore, it is possible to evaluate the trained machine learning model without causing a difference between users.

(2) In the above aspect, when at least one of (i) the training data and (ii) verification data is used as the evaluation data in the step (a), the verification data being not used for training of the machine learning model and including the input data and the prior label associated with the input data, the step (a2) may include the steps of obtaining a self-class spectral similarity that is the spectral similarity between the feature spectrum and a self-class known feature spectrum of the same class as an evaluation class indicated by the prior label associated with the evaluation data among the known feature spectrum group, for each of a plurality of the self-class known feature spectra, and obtaining a different-class spectral similarity that is the spectral similarity between the feature spectrum and a different-class known feature spectrum of a class different from the evaluation class among the known feature spectrum group, for each of a plurality of the different-class known feature spectra, the step (a3) may include the steps of obtaining a self-class maximum data similarity that is the similarity between the input data associated with the self-class known feature spectrum that is a calculation source of a self-class maximum spectral similarity indicating a maximum value among a plurality of the self-class spectral similarities and the evaluation data, and obtaining a different-class maximum data similarity that is the similarity between the input data associated with the different-class known feature spectrum that is a calculation source of a different-class maximum spectral similarity indicating a maximum value among a plurality of the different-class spectral similarities and the evaluation data, and the step (a4) may include the step of generating the first explanatory information including self-class spectral similarity information related to the self-class maximum spectral similarity, self-class data similarity information related to the self-class maximum data similarity, different-class spectral similarity information related to the different-class maximum spectral similarity, and different-class data similarity information related to the different-class maximum data similarity. According to this aspect, it is possible to generate and output the second explanatory information indicating a more detailed evaluation of the trained machine learning model using the first explanatory information including more types of information. This makes it possible to efficiently improve the machine learning model based on the evaluation of the machine learning model.

(3) In the above aspect, when the training data is used as the evaluation data in the step (a), the step (b) may include the step of (b1) generating the second explanatory information using a first training comparison result between a value indicated by the different-class spectral similarity information and a predetermined first different-class spectral similarity threshold and a second training comparison result between a value indicated by the different-class data similarity information and a predetermined first different-class data similarity threshold. According to this aspect, it is possible to generate the second explanatory information using the first training comparison result and the second training comparison result.

(4) In the above aspect, the step (b1) may include the step of generating, as the second explanatory information, information indicating at least one of a fact that there is inappropriate incomplete data in the training data and a fact that information of the training data is insufficient as information necessary for class discrimination, when the value indicated by the different-class spectral similarity information is equal to or greater than the first different-class spectral similarity threshold and the value indicated by the different-class data similarity information is equal to or greater than the first different-class data similarity threshold. According to this aspect, it is possible to generate the second explanatory information indicating a specific evaluation. This makes it possible to improve the machine learning model, the evaluation data, and the training data more efficiently based on the evaluation of the machine learning model.

(5) In the above aspect, the step (b1) may include the step of generating, as the second explanatory information, information indicating that there is a possibility that the machine learning model lacks capability of correctly performing class discrimination of the evaluation data, when the value indicated by the different-class spectral similarity information is equal to or greater than the first different-class spectral similarity threshold and the value indicated by the different-class data similarity information is less than the first different-class data similarity threshold. According to this aspect, it is possible to generate the second explanatory information indicating a specific evaluation. This makes it possible to improve the machine learning model, the evaluation data, and the training data more efficiently based on the evaluation of the machine learning model.

(6) In the above aspect, when the plurality of pieces of training data are used as the evaluation data in the step (a), the step (b) may include the step of (b2) generating, as the second explanatory information, at least one of first training evaluation information indicating that a variation in the input data included in the plurality of pieces of training data used as the evaluation data is large and second training evaluation information indicating that the input data included in the plurality of pieces of training data used as the evaluation data includes outlier data, when a value indicated by the self-class spectral similarity information is less than a predetermined first self-class spectral similarity threshold. According to this aspect, it is possible to generate the second explanatory information indicating a specific evaluation. This makes it possible to improve the machine learning model, the evaluation data, and the training data more efficiently based on the evaluation of the machine learning model.

(7) In the above aspect, the step (b2) may include the steps of generating the first training evaluation information as the second explanatory information when a number of pieces of the training data as the evaluation data satisfying that the value indicated by the self-class spectral similarity information is less than the first self-class spectral similarity threshold is equal to or greater than a predetermined first data threshold, and generating the second training evaluation information as the second explanatory information when a number of pieces of the training data as the evaluation data satisfying that the value indicated by the self-class spectral similarity information is less than the first self-class spectral similarity threshold is less than the first data threshold. According to this aspect, it is possible to generate the second explanatory information indicating more specific evaluation. This makes it possible to improve the machine learning model, the evaluation data, and the training data more efficiently based on the evaluation of the machine learning model.

(8) In the above aspect, when the verification data is used as the evaluation data in the step (a), the step (b) may include the step of (b3) generating the second explanatory information using a first verification comparison result between a value indicated by the different-class spectral similarity information and a predetermined second different-class spectral similarity threshold and a second verification comparison result between a value indicated by the different-class data similarity information and a predetermined second different-class data similarity threshold. According to this aspect, it is possible to generate the second explanatory information using the first verification comparison result and the second verification comparison result.

(9) In the above aspect, the step (b3) may include the step of generating, as the second explanatory information, information indicating at least one of a fact that there is inappropriate incomplete data in the verification data and a fact that information of the verification data is insufficient as information necessary for class discrimination, when the value indicated by the different-class spectral similarity information is equal to or greater than the second different-class spectral similarity threshold and the value indicated by the different-class data similarity information is equal to or greater than the second different-class data similarity threshold. According to this aspect, it is possible to generate the second explanatory information indicating a specific evaluation. This makes it possible to improve the machine learning model, the evaluation data, and the training data more efficiently based on the evaluation of the machine learning model.

(10) In the above aspect, the step (b3) may include the step of generating, as the second explanatory information, information indicating that there is a possibility that the machine learning model lacks capability of correctly performing class discrimination of the evaluation data, when the value indicated by the different-class spectral similarity information is equal to or greater than the second different-class spectral similarity threshold and the value indicated by the different-class data similarity information is less than the second different-class data similarity threshold. According to this aspect, it is possible to generate the second explanatory information indicating more specific evaluation. This makes it possible to improve the machine learning model, the evaluation data, and the training data more efficiently based on the evaluation of the machine learning model.

(11) In the above aspect, when a plurality of pieces of the verification data are used as the evaluation data in the step (a), the step (b) may include the step of (b4) generating, as the second explanatory information, at least one of first verification evaluation information indicating that a feature difference between the input data included in the plurality of pieces of verification data and the input data included in the training data is large and second verification evaluation information indicating that there is outlier data in a plurality of pieces of the input data included in the plurality of pieces of verification data, when the value indicated by the self-class spectral similarity information is less than a predetermined second self-class spectral similarity threshold and the value indicated by the self-class data similarity information is less than a predetermined self-class data similarity threshold. According to this aspect, it is possible to generate the second explanatory information indicating more specific evaluation. This makes it possible to improve the machine learning model, the evaluation data, and the training data more efficiently based on the evaluation of the machine learning model.

(12) In the above aspect, the step (b4) may include the steps of generating the first verification evaluation information as the second explanatory information when a number of pieces of the verification data as the evaluation data satisfying that the value indicated by the self-class spectral similarity information is less than the second self-class spectral similarity threshold and the value indicated by the self-class data similarity information is less than the self-class data similarity threshold is equal to or greater than a predetermined second data threshold, and generating the second verification evaluation information as the second explanatory information when a number of pieces of the verification data as the evaluation data satisfying that the value indicated by the self-class spectral similarity information is less than the second self-class spectral similarity threshold and the value indicated by the self-class data similarity information is less than the self-class data similarity threshold is less than the second data threshold. According to this aspect, it is possible to generate the second explanatory information indicating more specific evaluation. This makes it possible to improve the machine learning model, the evaluation data, and the training data more efficiently based on the evaluation of the machine learning model.

(13) In the above aspect, the step (b3) may include the step of generating, as the second explanatory information, information indicating that over-training of the machine learning model occurs when the value indicated by the self-class spectral similarity information is less than the second self-class spectral similarity threshold and the value indicated by the self-class data similarity information is equal to or greater than the self-class data similarity threshold. According to this aspect, it is possible to generate the second explanatory information indicating a specific evaluation. This makes it possible to improve the machine learning model, the evaluation data, and the training data more efficiently based on the evaluation of the machine learning model.

(14) In the above aspect, in the step (a4), the self-class spectral similarity information may include information of at least one of a representative value of a distribution of the plurality of self-class spectral similarities and the self-class maximum spectral similarity, and the different-class spectral similarity information may include information of at least one of a representative value of a distribution of the plurality of different-class spectral similarities and the different-class maximum spectral similarity. According to this aspect, the distribution of the spectral similarity or the maximum spectral similarity can be used as the self-class spectral similarity information or the different-class spectral similarity information.

(15) In the above aspect, when abnormal data is used as the evaluation data in the step (a), the abnormal data being not associated with the prior label and being assumed to be classified as an unknown class different from a class corresponding to the prior label, the step (a2) may include the step of specifying a maximum spectral similarity of a maximum value among the spectral similarities obtained for each of the plurality of known feature spectra, the step (a3) may include the step of obtaining a maximum data similarity that is a similarity between the input data associated with the known feature spectrum that is a calculation source of the maximum spectral similarity specified in the step (a2) and the abnormal data, and the step (a4) may include the step of generating the first explanatory information including spectral similarity information related to the spectral similarity and the maximum data similarity. According to this aspect, it is possible to generate and output the second explanatory information using the abnormality data.

(16) In the above aspect, when the abnormal data is used as the evaluation data in the step (a), the step (b) may include the step of generating, as the second explanatory information, information indicating that there is a possibility that the machine learning model lacks capability of correctly performing class discrimination of the abnormal data when the maximum spectral similarity is equal to or greater than a predetermined abnormal spectrum threshold and the maximum data similarity is less than a predetermined abnormal data similarity threshold. According to this aspect, it is possible to generate the second explanatory information indicating a specific evaluation. This makes it possible to improve the machine learning model, the evaluation data, and the training data more efficiently based on the evaluation of the machine learning model.

(17) In the above aspect, when the abnormal data is used as the evaluation data in the step (a), the step (b) may include the step of generating, as the second explanatory information, information indicating that information of the abnormal data is insufficient as information necessary for class discrimination when the maximum spectral similarity is equal to or greater than a predetermined abnormal spectrum threshold and the maximum data similarity is equal to or greater than a predetermined abnormal data similarity threshold. According to this aspect, it is possible to generate the second explanatory information indicating a specific evaluation. This makes it possible to improve the machine learning model, the evaluation data, and the training data more efficiently based on the evaluation of the machine learning model.

(18) According to a second aspect of the present disclosure, there is provided an evaluation device for a trained machine learning model. The evaluation device includes a memory configured to store the machine learning model, the machine learning model being a vector neural network model including a plurality of vector neuron layers, the machine learning model being trained by using a plurality of pieces of training data including input data and a prior label associated with the input data, and a processor, wherein the processor is configured to execute the following processes (a) inputting evaluation data to the trained machine learning model to generate first explanatory information used for an evaluation of the machine learning model, (b) using a value indicated by each piece of information included in the first explanatory information to generate second explanatory information indicating an evaluation of the trained machine learning model, and (c) outputting the generated second explanatory information, wherein the process (a) includes the following processes (a1) inputting the evaluation data to the trained machine learning model to obtain a feature spectrum from an output of a specific layer of the trained machine learning model, (a2) obtaining a spectral similarity that is a similarity between the feature spectrum and a known feature spectrum included in a known feature spectrum group obtained from an output of the specific layer by inputting the plurality of pieces of training data to the trained machine learning model again, for each of a plurality of the known feature spectra included in the known feature spectrum group, (a3) obtaining a data similarity that is a similarity between the input data and the evaluation data, and (a4) generating the first explanatory information including spectral similarity information related to the spectral similarity and data similarity information related to the data similarity. According to this aspect, it is possible to generate and output the second explanatory information indicating the evaluation of the trained machine learning model using the first explanatory information including the spectral similarity information and the data similarity information. Therefore, it is possible to evaluate the trained machine learning model without causing a difference between users.

(19) According to a third aspect of the present disclosure, there is provided a non-transitory computer-readable storage medium storing a program for causing a computer to execute evaluation of a trained machine learning model. The machine learning model is a vector neural network model including a plurality of vector neuron layers, and is trained by using a plurality of pieces of training data including input data and a prior label associated with the input data. The computer program causes the computer to execute the following functions (a) inputting evaluation data to the trained machine learning model to generate first explanatory information used for an evaluation of the machine learning model, (b) using a value indicated by each piece of information included in the first explanatory information to generate second explanatory information indicating an evaluation of the trained machine learning model, and (c) outputting the generated second explanatory information, wherein the function (a) includes the following functions (a1) inputting the evaluation data to the trained machine learning model to obtain a feature spectrum from an output of a specific layer of the trained machine learning model, (a2) obtaining a spectral similarity that is a similarity between the feature spectrum and a known feature spectrum included in a known feature spectrum group obtained from an output of the specific layer by inputting the plurality of pieces of training data to the trained machine learning model again, for each of a plurality of the known feature spectra included in the known feature spectrum group, (a3) obtaining a data similarity that is a similarity between the input data and the evaluation data, and (a4) generating the first explanatory information including spectral similarity information related to the spectral similarity and data similarity information related to the data similarity. According to this aspect, it is possible to generate and output the second explanatory information indicating the evaluation of the trained machine learning model using the first explanatory information including the spectral similarity information and the data similarity information. Therefore, it is possible to evaluate the trained machine learning model without causing a difference between users.

The present disclosure can be realized in various forms other than the above. For example, the present disclosure can be realized in a form of a non-transitory storage medium, etc. in which the computer program is recorded.

What is claimed is:

1. An evaluation method for a trained machine learning model, the machine learning model being a vector neural network model including a plurality of vector neuron layers and being trained by using a plurality of pieces of training data including input data and a prior label associated with the input data,
the evaluation method comprising steps of:
(a) inputting evaluation data to the trained machine learning model to generate first explanatory information to be used for an evaluation of the machine learning model;
(b) using a value indicated by each piece of information included in the first explanatory information, to generate second explanatory information indicating an evaluation of the trained machine learning model; and
(c) outputting the generated second explanatory information, wherein the step (a) includes steps of:
(a1) inputting the evaluation data to the trained machine learning model to obtain a feature spectrum from an output of a specific layer of the trained machine learning model;
(a2) obtaining a spectral similarity that is a similarity between the feature spectrum and a known feature spectrum included in a known feature spectrum group obtained from an output of the specific layer by inputting the plurality of pieces of training data to the trained machine learning model again, for each known feature spectrum of a plurality of known feature spectra included in the known feature spectrum group;
(a3) obtaining a data similarity that is a similarity between the input data and the evaluation data; and
(a4) generating the first explanatory information including spectral similarity information related to the spectral similarity, and data similarity information related to the data similarity.

2. The evaluation method according to claim 1, wherein
when at least one of (i) the training data or (ii) verification data is used as the evaluation data in the step (a), the verification data being not used for training of the machine learning model and including the input data and the prior label associated with the input data,
the step (a2) includes:
obtaining a self-class spectral similarity that is the spectral similarity between the feature spectrum and a self-class known feature spectrum of a same class as an evaluation class indicated by the prior label associated with the evaluation data among the known feature spectrum group, for each self-class known feature spectrum of a plurality of self-class known feature spectra; and
obtaining a different-class spectral similarity that is the spectral similarity between the feature spectrum and a different-class known feature spectrum of a class different from the evaluation class among the known feature spectrum group, for each different-class known feature spectrum of a plurality of different-class known feature spectra;
the step (a3) includes
obtaining a self-class maximum data similarity that is the similarity between the input data associated with the self-class known feature spectrum that is a calculation source of a self-class maximum spectral similarity indicating a maximum value of a plurality of self-class spectral similarities, and the evaluation data, and
obtaining a different-class maximum data similarity that is the similarity between the input data associated with the different-class known feature spectrum that is a calculation source of a different-class maximum spectral similarity indicating a maximum value of a plurality of the different-class spectral similarities, and the evaluation data; and
the step (a4) includes
generating the first explanatory information including self-class spectral similarity information related to the self-class maximum spectral similarity, self-class data similarity information related to the self-class maximum data similarity, different-class spectral similarity information related to the different-class maximum spectral similarity, and different-class data similarity information related to the different-class maximum data similarity.

3. The evaluation method according to claim 2, wherein
when the training data is used as the evaluation data in the step (a),
the step (b) includes a step of
(b1) generating the second explanatory information using a first training comparison result between a value indicated by the different-class spectral similarity information and a predetermined first different-class spectral similarity threshold and a second training comparison result between a value indicated by the different-class data similarity information and a predetermined first different-class data similarity threshold.

4. The evaluation method according to claim 3, wherein
the step (b1) includes
generating, as the second explanatory information, information indicating at least one of a fact that the training data includes inappropriate incomplete data or a fact that information about the training data is insufficient as information necessary for class discrimination, when the value indicated by the different-class spectral similarity information is the first different-class spectral similarity threshold or greater, and the value indicated by the different-class data similarity information is the first different-class data similarity threshold or greater.

5. The evaluation method according to claim 3, wherein
the step (b1) includes
generating, as the second explanatory information, information indicating that there is a possibility that the machine learning model lacks a capability of correctly performing class discrimination of the evaluation data, when the value indicated by the different-class spectral similarity information is the first different-class spectral similarity threshold or greater and the value indicated by the different-class data similarity information is less than the first different-class data similarity threshold.

6. The evaluation method according to claim 3, wherein
when a plurality of pieces of training data are used as the evaluation data in the step (a),
the step (b) includes a step of
(b2) generating, as the second explanatory information, at least one of first training evaluation information indicating that a variation in the input data included in the plurality of pieces of training data used as the evaluation data is large, or second training evaluation information indicating that the input data included in the plurality of pieces of training data used as the evaluation data includes outlier data, when a value indicated by the self-class spectral similarity information is less than a predetermined first self-class spectral similarity threshold.

7. The evaluation method according to claim 6, wherein
the step (b2) includes
generating the first training evaluation information as the second explanatory information when the number of pieces of the training data as the evaluation data satisfying that the value indicated by the self-class spectral similarity information is less than the first self-class spectral similarity threshold is a predetermined first data threshold or greater, and
generating the second training evaluation information as the second explanatory information when the number of pieces of the training data as the evaluation data satisfying that the value indicated by the self-class spectral similarity information is less than the first self-class spectral similarity threshold is less than the first data threshold.

8. The evaluation method according to claim 2, wherein
when the verification data is used as the evaluation data in the step (a),
the step (b) includes a step of
(b3) generating the second explanatory information using a first verification comparison result between the value indicated by the different-class spectral similarity information and a predetermined second different-class spectral similarity threshold, and a second verification comparison result between the value indicated by the different-class data similarity information and a predetermined second different-class data similarity threshold.

9. The evaluation method according to claim 8, wherein
the step (b3) includes
generating, as the second explanatory information, information indicating at least one of a fact that the verification data includes inappropriate incomplete data or a fact that information about the verification data is insufficient as information necessary for class discrimination, when the value indicated by the different-class spectral similarity information is the second different-class spectral similarity threshold or greater, and the value indicated by the different-class data similarity information is the second different-class data similarity threshold or greater.

10. The evaluation method according to claim 8, wherein
the step (b3) includes
generating, as the second explanatory information, information indicating that there is a possibility that the machine learning model lacks a capability of correctly performing class discrimination of the evaluation data, when the value indicated by the different-class spectral similarity information is the second different-class spectral similarity threshold or greater, and the value indicated by the different-class data similarity information is less than the second different-class data similarity threshold.

11. The evaluation method according to claim 8, wherein
when a plurality of pieces of verification data are used as the evaluation data in the step (a),
the step (b) includes a step of
(b4) generating, as the second explanatory information, at least one of first verification evaluation information indicating that a feature difference between the input data included in the plurality of pieces of verification data and the input data included in the training data is large, or second verification evaluation information indicating that a plurality of pieces of the input data included in the plurality of pieces of verification data include outlier data, when the value indicated by the self-class spectral similarity information is less than a predetermined second self-class spectral similarity threshold, and the value indicated by the self-class data similarity information is less than a predetermined self-class data similarity threshold.

12. The evaluation method according to claim 11, wherein
the step (b4) includes
generating the first verification evaluation information as the second explanatory information when the number of pieces of the verification data as the evaluation data satisfying that the value indicated by the self-class spectral similarity information is less than the second self-class spectral similarity threshold, and the value indicated by the self-class data similarity information is less than the self-class data similarity threshold is a predetermined second data threshold or greater, and
generating the second verification evaluation information as the second explanatory information when the number of pieces of the verification data as the evaluation data satisfying that the value indicated by the self-class spectral similarity information is less than the second self-class spectral similarity threshold, and the value indicated by the self-class data similarity information is less than the self-class data similarity threshold is less than the second data threshold.

13. The evaluation method according to claim 11, wherein
the step (b3) includes
generating, as the second explanatory information, information indicating that over-training of the machine learning model occurs when the value indicated by the self-class spectral similarity information is less than the second self-class spectral similarity threshold, and the value indicated by the self-class data similarity information is the self-class data similarity threshold or greater.

14. The evaluation method according to claim 2, wherein
in the step (a4),
the self-class spectral similarity information includes information about at least one of a representative value of a distribution of the plurality of self-class spectral similarities or the self-class maximum spectral similarity, and
the different-class spectral similarity information includes information about at least one of a representative value of a distribution of the plurality of different-class spectral similarities or the different-class maximum spectral similarity.

15. The evaluation method according to claim 1, wherein
when abnormal data is used as the evaluation data in the step (a), the abnormal data being not associated with the prior label and being assumed to be classified as an unknown class different from a class corresponding to the prior label,
the step (a2) includes
specifying a maximum spectral similarity of a maximum value of the spectral similarities obtained for each of the plurality of known feature spectra,
the step (a3) includes
obtaining a maximum data similarity that is a similarity between the input data associated with the known feature spectrum that is a calculation source of the maximum spectral similarity specified in the step (a2) and the abnormal data, and
the step (a4) includes
generating the first explanatory information including spectral similarity information related to the spectral similarity, and the maximum data similarity.

16. The evaluation method according to claim 15, wherein
when the abnormal data is used as the evaluation data in the step (a),
the step (b) includes
generating, as the second explanatory information, information indicating that there is a possibility that the machine learning model lacks a capability of correctly performing class discrimination of the abnormal data, when the maximum spectral similarity is a predetermined abnormal spectrum threshold or greater, and the maximum data similarity is less than a predetermined abnormal data similarity threshold.

17. The evaluation method according to claim 15, wherein
when the abnormal data is used as the evaluation data in the step (a),
the step (b) includes
generating, as the second explanatory information, information indicating that information about the abnormal data is insufficient as information necessary for class discrimination, when the maximum spectral similarity is a predetermined abnormal spectrum threshold or greater, and the maximum data similarity is a predetermined abnormal data similarity threshold or greater.

18. An evaluation device for a trained machine learning model, the device comprising:
a memory configured to store the machine learning model, the machine learning model being a vector neural network model including a plurality of vector neuron layers and being trained by using a plurality of pieces of training data including input data and a prior label associated with the input data; and
one or more processors, wherein
the one or more processors is configured to execute:
(a) inputting evaluation data to the trained machine learning model to generate first explanatory information to be used for an evaluation of the machine learning model;
(b) using a value indicated by each piece of information included in the first explanatory information to generate second explanatory information indicating an evaluation of the trained machine learning model; and
(c) outputting the generated second explanatory information, and
the processing (a) includes processing of:
(a1) inputting the evaluation data to the trained machine learning model to obtain a feature spectrum from an output of a specific layer of the trained machine learning model;
(a2) obtaining a spectral similarity that is a similarity between the feature spectrum and a known feature spectrum included in a known feature spectrum group obtained from an output of the specific layer by inputting the plurality of pieces of training data to the trained machine learning model again, for each known feature spectrum of a plurality of the known feature spectra included in the known feature spectrum group;
(a3) obtaining a data similarity that is a similarity between the input data and the evaluation data; and
(a4) generating the first explanatory information including spectral similarity information related to the spectral similarity and data similarity information related to the data similarity.

19. A non-transitory computer-readable storage medium storing a program for causing one or more computers to execute evaluation of a trained machine learning model, the machine learning model being a vector neural network model including a plurality of vector neuron layers and being trained by using a plurality of pieces of training data including input data and a prior label associated with the input data,
the program causing the computer to execute functions of:
(a) inputting evaluation data to the trained machine learning model to generate first explanatory information used for an evaluation of the machine learning model;
(b) using a value indicated by each piece of information included in the first explanatory information to generate second explanatory information indicating an evaluation of the trained machine learning model; and
(c) outputting the generated second explanatory information, wherein
the function (a) includes functions of:
(a1) inputting the evaluation data to the trained machine learning model to obtain a feature spectrum from an output of a specific layer of the trained machine learning model;
(a2) obtaining a spectral similarity that is a similarity between the feature spectrum and a known feature spectrum included in a known feature spectrum group obtained from an output of the specific layer by inputting the plurality of pieces of training data to the trained machine learning model again, for each known feature spectrum of a plurality of the known feature spectra included in the known feature spectrum group;
(a3) obtaining a data similarity that is a similarity between the input data and the evaluation data; and
(a4) generating the first explanatory information including spectral similarity information related to the spectral similarity and data similarity information related to the data similarity.
